(19) United States
(12) Patent Application Publication
(10) Pub. No.: US 2026/0275685 A1
(43) Pub. Date: Sep. 17, 2026

(54) OPERATOR STATUS MONITORING

(71) Applicant: Oshkosh Corporation, Oshkosh, WI (US)

(72) Inventor: Korry Kobel, Oshkosh, WI (US)

(73) Assignee: Oshkosh Corporation, Oshkosh, WI (US)

(21) Appl. No.: 19/559,886

(22) Filed: Mar. 6, 2026

Related U.S. Application Data
(60) Provisional application No. 63/768,850, filed on Mar. 7, 2025.
(60) Provisional application No. 63/768,824, filed on Mar. 7, 2025.
(60) Provisional application No. 63/768,809, filed on Mar. 7, 2025.
(60) Provisional application No. 63/989,987, filed on Feb. 24, 2026.
(60) Provisional application No. 63/992,192, filed on Feb. 27, 2026.

(51) Int. Cl. E02F 9/24; E02F 9/20; E02F 9/26

(52) U.S. Cl. CPC E02F 9/24; E02F 9/2033; E02F 9/2054; E02F 9/265

(57) ABSTRACT

A monitoring system includes a vehicle comprising an actuator or a motor, an implement driven by the actuator, and a first sensor. The monitoring system also includes a controller configured to receive, from the first sensor, first sensor data associated with an operating condition of at least one of the actuator or the implement, receive, from a second sensor, second sensor data associated with a physical characteristic of an operator of the vehicle, determine, using the first sensor data and the second sensor data, an operating condition of the operator, and provide, based on the operating condition of the operator, an instruction to control an operation of at least one of the actuator, the motor or the implement of the vehicle.

### CROSS-REFERENCE TO RELATED PATENT APPLICATIONS

This Application claims the benefit of and priority to (i) U.S. Provisional Patent Application No. 63/768,809, filed Mar. 7, 2025, (ii) U.S. Provisional Patent Application No. 63/768,850, filed Mar. 7, 2025, (iii) U.S. Provisional Patent Application No. 63/768,824, filed Mar. 7, 2025, (iv) U.S. Provisional Patent Application No. 63/989,987, filed Feb. 24, 2026, and (v) U.S. Provisional Patent Application No. 63/992,192, filed Feb. 27, 2026, the entire disclosures of which are hereby incorporated by reference herein.

### BACKGROUND

Work equipment and their operators sometimes require tracking, tasking, and monitoring at a work site. Managers and operators of work sites typically rely on discrete systems, applications, and methods to monitor these operations.

### SUMMARY

One exemplary embodiment of the present disclosure relates to a monitoring system. The monitoring system includes a vehicle comprising an actuator or a motor, an implement driven by the actuator, and a first sensor. The monitoring system also includes a controller configured to receive, from the first sensor, first sensor data associated with an operating condition of at least one of the actuator or the implement, receive, from a second sensor, second sensor data associated with a physical characteristic of an operator of the vehicle, determine, using the first sensor data and the second sensor data, an operating condition of the operator, and provide, based on the operating condition of the operator, an instruction to control an operation of at least one of the actuator, the motor or the implement of the vehicle.

Another exemplary embodiment of the present disclosure relates to a monitoring system for monitoring a plurality of vehicles at a site. The monitoring system includes a controller configured to receive, from a first sensor, first sensor data associated with an operating condition of a first vehicle, receive, from the first sensor, second sensor data associated with a physical characteristic of an operator of the first vehicle, determine, using the first sensor data and the second sensor data, an operating condition of the operator, and provide, based on the operating condition of the operator, an instruction to control an operation of at least one of the first vehicle or a second vehicle.

Another exemplary embodiment of the present disclosure relates to a monitoring system. The monitoring system includes a vehicle, a work machine, and a user device. The user device includes a communication interface configured to be communicably coupled to each of the vehicle and the work machine, a user interface, and a controller configured to receive, via the user interface, a first input from a user, verify the first input based on a database, provide, via the user interface, access to data associated with at least one of the vehicle or the work machine based on the verification of the first input.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a connected PPE system, according to an exemplary embodiment.

FIG. 2 is a block diagram of the connected PPE system of FIG. 1 at a jobsite, according to an exemplary embodiment.

FIG. 3 is a block diagram of the connected PPE system of FIG. 1 on a user, according to an exemplary embodiment.

FIG. 4 is a flow diagram of a process 400 for performing an action using the connected PPE system of FIG. 1, according to an exemplary embodiment.

FIG. 5 is a flow diagram of a process 500 for using the connected PPE system of FIG. 1 as a gateway to a network, according to an exemplary embodiment.

FIG. 6 is a block diagram of a jobsite using the connected PPE system of FIG. 1, according to an exemplary embodiment.

FIG. 7 is a block diagram of the connected PPE system of FIG. 1 interacting with a vehicle, according to an exemplary embodiment.

FIG. 8 is a perspective view of the vehicle of FIG. 7, according to an exemplary embodiment.

FIG. 9 is a perspective view of a base of the vehicle of FIG. 7, according to an exemplary embodiment.

FIG. 10 is a perspective view of an axle assembly of the lift device of FIG. 7, according to an exemplary embodiment.

FIG. 11 is a perspective view of a platform assembly of the lift device of FIG. 7, according to an exemplary embodiment.

FIG. 12 is a block diagram of a user device at a jobsite, according to an exemplary embodiment.

FIG. 13 is a block diagram of a user device at a jobsite, according to an exemplary embodiment.

FIG. 14 is a schematic diagram of a user interface of the user device of FIG. 12 or FIG. 13, according to an exemplary embodiment.

FIG. 15 is a schematic diagram of the user device of FIG. 12 or FIG. 13 and a work machine, according to an exemplary embodiment.

FIG. 16 is a schematic representation of a work machine including a controller, according to an exemplary embodiment.

FIG. 17 is a schematic representation of a system, according to an exemplary embodiment.

FIG. 18 is a schematic representation of the system of FIG. 17 with a connectivity module, according to an exemplary embodiment.

FIG. 19 is a schematic representation of a site and equipment with the system of FIG. 17 deployed, according to an exemplary embodiment.

FIG. 20 is a schematic representation of a site with the system of FIG. 17 connecting a plurality of pieces of equipment, according to an exemplary embodiment.

FIG. 21 is a schematic representation of a system for monitoring one or more operations of the work machine of FIG. 16 and/or components of the system of FIG. 17, according to an exemplary embodiment.

FIG. 22 is a flow diagram of a process for performing an action using the system of FIG. 21, according to an exemplary embodiment.

FIG. 23 is a flow diagram of a process for performing an action using the system of FIG. 21, according to an exemplary some embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Work equipment (e.g., lifts, telehandlers, etc.) and their operators sometimes require tracking, tasking, and/or monitoring at a work site. However, work sites often encompass a large area, which involve the presence of many individuals and pieces of equipment. As such, it is often difficult to adequately monitor the conditions under which each operator and/or equipment is performing. Beneficially, the systems and methods described herein provide the ability to monitor conditions of one or more operators and control operations of one or more vehicles (and/or the components thereof, etc.), for example based on the conditions (e.g., physical condition, etc.) of vehicle operators. In this regard, the systems and methods described herein integrate, connect, and/or control operations, for example to limit or prevent operator/operating conditions that may potentially pose dangers to individuals, equipment, and/or spaces at a site.

As described herein, the term “personal protective equipment (PPE)” may refer to equipment or devices worn, carried, or displayed by persons to protect from dangers or hazards. PPE may include but are not limited to wearable elements or devices such as helmets (e.g., hardhats), eye protection (e.g., safety glasses), vests, lanyards, and other types of clothing and/or accessories worn for safety and security purposes. Hard hats, safety glasses, vest, and lanyards are each examples of different types of PPE. Hard hats may be worn on the head of a user (e.g., including a strap that is secured around the user's head) to protect the user from impacts with objects in the surrounding environment. Safety glasses may include arms that engage with a user's ears and lenses that cover the user's eyes to protect the eyes from contact with debris. Vests may be worn on the torso of a user and may make the user more visible (e.g., through the use of bright colors) or otherwise identify the user (e.g., through text printed on the vest). A lanyard may be used to secure a harness worn by a user to a secure attachment point (e.g., on a platform of a lift device), forming a fall arrest system that arrests the user in the event of a fall. In some instances, the PPE may include one or more sensors, for example for monitoring characteristics associated with a user or operator. Certain PPE may represent a subset of wearable devices. By way of example, wearable devices may include other types of devices that are worn by persons but not configured as PPE.

As utilized herein, the term “sensor” or “sensors” may refer to one or more devices that detect, record, monitor, and/or communicate one or more properties or characteristics associated with the device, or a surrounding component, device, or space. The sensor or sensors may include a wave sensor (e.g., a millimeter wave sensor, etc.), which may utilize short-wavelength waves (e.g., electromagnetic waves, etc.) to determine properties or characteristics associated with the sensor and/or a surrounding area (e.g., movement, acceleration, angles, etc.). The sensor or sensors may include a capacitive sensor, which may utilize electrostatic fields to detect the conditions and/or presence of certain materials or objects (e.g., liquid, metals, plastics, wood, persons, etc.). The sensor or sensors may also include environmental sensors (e.g., sensors measuring temperature, humidity, pressure, air quality, light, sound, radiation, etc.), biometric sensors (e.g., sensors for measuring heart rate, blood oxygen levels, blood pressure, perspiration, etc.), position sensors (e.g., proximity sensors, GPS receivers, etc.), mapping or imaging sensors (e.g., LIDAR sensors, light curtains, cameras, ultrasonic sensors, etc.) orientation or acceleration sensors (e.g., accelerometers, gyroscopic sensors, inertial measurement units, compasses, etc.), and/or other suitable sensors.

As utilized herein, the terms “work machine,” “machine,” or “work device” may refer to a lift device (e.g., an articulating boom lift, a telescoping boom lift, a compact crawler boom lift, a toucan mast boom lift, etc.). The terms “work machine,” “machine,” or “work device” may also refer to a telehandler, a scissor lift, a refuse truck, a mixer truck, a fire fighting truck, and/or another suitable vehicle or piece of equipment or machinery.

Referring generally to the figures, personal protective equipment (PPE) may be worn by operators at a worksite to protect from jobsite hazards. PPE may include wearable elements or devices such as hardhats, safety glasses, vests, lanyards, and other types of clothing and accessories worn for safety and security purposes at a worksite. The PPE may include one or more sensors for monitoring the operator and/or the jobsite. The one or more sensors may include environmental sensors (e.g., sensors measuring temperature, humidity, pressure, air quality, light, sound, radiation, etc.), biometric sensors (e.g., sensors for measuring heart rate, blood oxygen levels, blood pressure, perspiration, etc.), position sensors (e.g., proximity sensors, GPS receivers, etc.), mapping or imaging sensors (e.g., LIDAR sensors, light curtains, cameras, ultrasonic sensors, etc.) and/or orientation or acceleration sensors (e.g., accelerometers, gyroscopic sensors, inertial measurement units, compasses, etc.). The PPE may include a user interface to receive information and/or provide information to a wearer of the PPE and others around the PPE. The user interface may include lights, speakers, vibration motors, heads up displays, augmented reality displays, virtual reality displays, tactile displays, etc. The PPE may communicate over a network using one or more wireless communication protocols (e.g., Bluetooth, NFC, Zigbee, radio, WiFi, cellular, satellite, etc.). The PPE may act as a hub or gateway for other devices (e.g., personal computing devices, separate sensors, etc.) to communicate over the network through the PPE. The PPE may also be communicably coupled with other devices or machines at the worksite such as vehicles, equipment, tools, a user device, such that a wearer of the PPE may control the other devices and/or receive information from the other devices. The user device or devices may be communicably coupled to each of the PPE and the one or more vehicles, equipment, or tools. For example, the user device may be a central hub communicably coupled to each of the PPE, vehicles, equipment, and devices at the jobsite. Jobsites with many operators and vehicles can use the network-connected PPE and user device(s) for monitoring operator safety, security, and efficiency across the jobsite, to coordinate with the operators for jobsite tasks, and to control operation of various vehicles and equipment. Beneficially, the ability to monitor and control through the connected PPE means additional equipment is not required and PPE adoption and use can be monitored in addition to the monitoring of other operator and jobsite conditions.

Referring to the figures generally, various exemplary embodiments disclosed herein relate to a monitoring system for monitoring conditions at a site (e.g., a job site, a storage facility, a rental facility, a manufacturing facility, etc.). The system may be configured to receive sensor data associated with an operating condition of a vehicle and sensor data associated with a physical characteristic of an operator of the vehicle. The physical characteristic may be, for example, a heart rate of the operator, a breathing characteristic of the operator (e.g., rapid breathing, labored or shallow breathing, etc.), a posture of the operator (e.g., slouched or slumped, etc.), movement trends of tendencies of the operator (e.g., looking away from a path of travel, looking down, etc.), which may be representative of a condition of the operator (e.g., tired, exhausted, stressed, nervous, etc.). Based on this information, the systems and methods described herein may be configured to provide an instruction to control an operation of one or more vehicles, devices, and/or systems, for example to prevent, limit, and/or avoid potentially dangerous conditions at the site.

### Personal Protective Equipment (PPE)

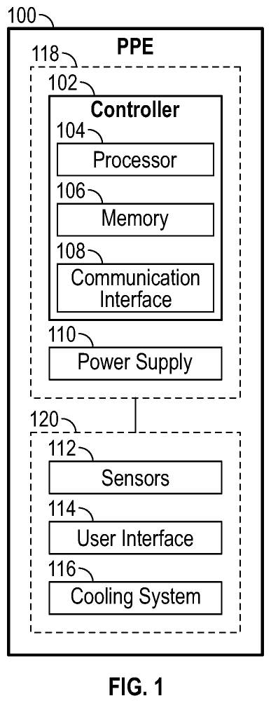

Referring to FIG. 1, a wearable device(s) (e.g., hardhat, pair of safety glasses, vest, lanyard or other type of personal protective equipment) is shown as PPE 100, according to an exemplary embodiment. The PPE 100 includes a controller 102 that controls operation of the PPE 100. The controller 102 includes a processing circuit, shown as processor 104, and a memory device, shown as memory 106. The memory 106 may contain one or more instructions that, when executed by the processor 104, cause the processor to perform the various functions described herein. In other embodiments, the controller 102 and/or other components of the PPE 100 are incorporated into another type of wearable device, such as a piece of jewelry (e.g., a watch, a necklace, etc.), a piece of clothing (e.g., a shirt, a jacket, pants, a shoe, etc.), or another type of wearable device. In other embodiments, the controller 102 and/or other components of the PPE 100 may be removably coupled to or positioned in a piece of jewelry or clothing.

The controller 102 further includes a communication interface 108 (e.g., a communication circuit, a network interface, etc.) that facilitates communication with (e.g., to and from) other components of the PPE 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The PPE 100 further includes one or more energy storage and/or supply devices, shown as power supply 110. The power supply 110 may be or include batteries, capacitors, solar panels, or other types of power supplies. The power supply 110 may deliver electrical energy to other components of the PPE 100 to power the PPE 100. The power supply 110 may be charged by an outside source of energy (e.g., an electrical grid, a wireless charging interface, etc.). In some embodiments, the PPE 100 includes another type of power supply such as an AC input for direct connection to the outside source of energy.

The PPE 100 includes one or more sensors 112 operatively coupled to the controller 102. The sensors 112 may provide sensor data describing the current status of the PPE 100, the surrounding environment, and/or a wearer of the PPE. By way of example, the sensors 112 may include mapping or imaging sensors (e.g., LIDAR sensors, light curtains, cameras, ultrasonic sensors, etc.). The mapping or imaging sensors may map or image the environment around the PPE 100. For example, the sensors 112 may include cameras for monitoring obstacles and objects around the PPE 100. The sensors 112 can detect if an object is on a collision course with the PPE 100 and provide an alert (e.g., vibration, visual alert on a display, alarm) etc. indicating the impact but also the direction of the object and/or a direction to move to avoid the object. By way of example, the sensors 112 may include position sensors (e.g., GPS, proximity sensors, etc.). By way of example, the sensors 112 may include orientation or acceleration sensors (e.g., accelerometers, gyroscopic sensors, inertial measurement units, compasses, etc.). The orientation sensors may monitor an orientation of the wearer including a direction of movement and/or a direction of sight. For example, in embodiments with the PPE 100 configured as a hardhat, the orientation sensors may determine in which direction a wearer of the hardhat is looking. In some embodiments, the orientation and acceleration sensors can also be used for fall and/or hit detection. For example, an accelerometer or other orientation or acceleration sensor may be used to determine if the PPE 100 experiences an impact such as a hit or is falling. By way of example, the sensors 112 may include environmental sensors (e.g., sensors measuring temperature, humidity, pressure, air quality, light, sound, radiation, etc.). For example, in some embodiments the environmental sensors include an altimeter or a relative pressure sensing system (or a part thereof) for determining an altitude or height of the PPE 100. In some embodiments, the altitude or height is a relative value as compared to another altitude or height obtained from an external device via the communication interface 108. For example, a vehicle 10 may monitor the vehicle altitude and provide the vehicle information include the vehicle altitude to the PPE 100 via the communication interface 108 and the communication interface 108 may therefore determine the altitude of the PPE 100 relative to the vehicle 10 by using both the vehicle information and the information from the sensors 112. By way of example, the sensors may include biometric sensors (e.g., sensors for measuring heart rate, blood oxygen levels, blood pressure, perspiration, etc.). The biometric sensors may monitor a state or condition of a wearer of the PPE 100. The information derived from the sensors 112 (e.g., mapping and imaging information, orientation and acceleration information, environmental information, and/or biometric information) may be provided to the wearer of the PPE 100 and to external devices over one or more networks via the communication interface 108.

The PPE 100 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The displays may include touch displays, heads up displays, augmented reality displays, and/or virtual reality displays, amongst other displays. The user interface 114 may include input devices that receive information (e.g., commands) from one or more users. By way of example, the user interface 114 may include buttons, switches, knobs, touchscreens, microphones, cameras or other input devices.

For example, in some embodiments the user interface 114 may include one or more lights. The one or more lights may be positioned at various points around the PPE 100 depending on the purpose of the lights. For example, a light of the one or more lights may be positioned under a brim of a PPE 100 configured as a hardhat to communicate information to a wearer of the PPE 100 In some embodiments, a light may be positioned on an outer surface such as a top of the PPE 100. In such embodiments, the light may provide information to those (e.g., other people, machines, vehicles, etc.) around the wearer. The lights may be operated together or may be operated separately to confer different pieces of information.

The PPE 100 includes a cooling system 116. The cooling system 116 may include a fan, a mister, a heat exchanger, or another type of cooling system to cool a wearer of the PPE 100.

The controller 102 is coupled to each of the sensors 112, the user interface 114 and the cooling system 116 for both receiving information (e.g., from sensors 112) and/or controlling the operation of the PPE 100 (e.g., the user interface 114, the cooling system 116, etc.).

In some embodiments, the components of the PPE 100 are split between a plurality of bases or support elements. In other embodiments, the components of the PPE 100 are positioned on or supposed by the same underlying support structure. For example, the controller 102 and the power supply 110 may be positioned in or supported by a first support structure, coupler, or wearable component, shown as first wearable portion 118, while other components of PPE 100 such as the sensors 112, the user interface 114, and the cooling system 116 are positioned in or supported by a second support structure, coupler, or wearable component, shown as second wearable portion 120. The first wearable portion 118 may be communicably and/or electrically connected to the second wearable portion 120 either via wires or wirelessly. In such an example, the first wearable portion 118 may thus act as a compute puck, and the second wearable portion 120 may be a modified piece of PPE such as a hardhat, a pair of glasses, a vest, a lanyard, etc. In some embodiments, both the first wearable portion 118 and the second wearable portion 120 are pieces of PPE. For example, the first wearable portion may be a hardhat and the second wearable portion 120 may be a pair of safety glasses. In such embodiments, heavier components of the PPE can be positioned on the hardhat for improved weight distribution, while other components such as user interface 114 elements may be placed on the safety glasses to allow for providing the wearer with visual warnings through the display. It should be understood that the arrangement of components in the first wearable portion 118 and the second wearable portion 120 in FIG. 1 is illustrative only, and all or part of any components of PPE 100 may be positioned elsewhere in the PPE 100 in other portions. For example, in some embodiments, the user interface 114 may be divided between the first wearable portion 118 and the second wearable portion 120. For another example, the controller 102 may be distributed with components of the controller 102 in both the first wearable portion 118 and the second wearable portion 120.

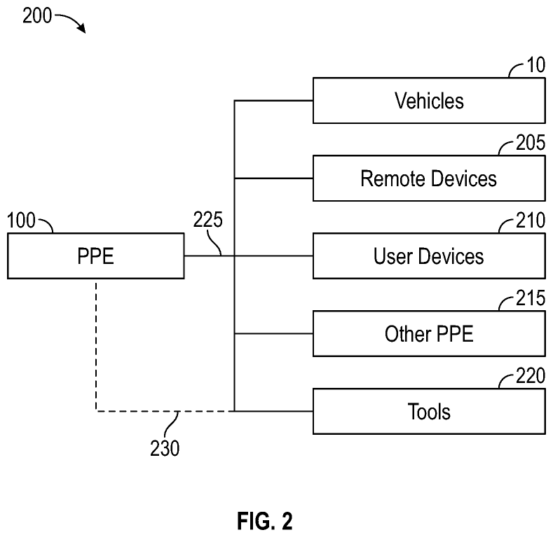

Referring now to FIG. 2, the PPE 100 may be coupled to other external devices or machines via the communication interface 108. The PPE 100 may be coupled to a vehicle 10 or a user device (e.g., a user device 1110). The vehicle 10 may be any type of vehicle or work machine (e.g., boom lift, scissor lift, refuse truck, mixer truck, fire fighting truck, etc.) on a jobsite with the PPE 100. In some embodiments, the vehicle 10 can communicate information obtained from one or more sensors on the vehicle 10 to the PPE 100 and the PPE 100 can communicate information (e.g., obtained from the sensors 112) to the vehicle 10. In some embodiments, one or more actions can be performed (e.g., by the controller 102) based on the information from the vehicle 10 and/or the PPE 100.

For example, the movement or operation of the vehicle 10 may be controlled based on data from the PPE 100. In such examples, the controller 102 may provide a command or instruction to the vehicle 10, and a controller onboard the vehicle may process the command or instruction to carry out the action within the command or instruction. The actions can include movement of the vehicle 10 or a portion thereof (e.g., an actuator, a lift device, an end effector, a climate control system, a lighting system, an ignition system, a security system, a steering system, etc.). In some embodiments, the available actions to be performed based on the PPE 100 are dependent on an identify of the PPE 100 or a wearer of the PPE 100. For example, a PPE 100 associated with a site manager may have permissions to perform a first plurality of actions or all possible actions, while a PPE 100 associated with a maintenance worker may have permissions to perform a second plurality of actions. The second plurality may be different than and/or smaller than the first plurality of actions.

In some embodiments, the PPE 100 may also perform one or more actions based on a command or instruction from the vehicle 10. For example, if a climate control system in the vehicle 10 is on and the PPE 100 is sensed to be in the vehicle 10, the vehicle 10 may provide a command or instruction to the PPE 100 to turn of the cooling system 116 of the PPE 100, so that the vehicle 10 climate control system can do the work. Beneficially, the ability of the PPE 100 to communicate with the vehicle 10 allows the PPE 100 to integrate into a network system allowing for automatic actions to be taken based on information obtained by both the PPE 100 and the vehicle 10.

The PPE 100 may be connected to one or more remote devices 205 (e.g., servers). In some embodiments, a remote device 205 functions as site manager that controls various operations throughout jobsite. The site manager may monitor the positions of individuals and equipment on the jobsite via the PPE 100 or other sensors (e.g., sensors on vehicle 10) and may control one or more machines or pieces of equipment on the jobsite based on such information. The remote device 205 may thus monitor the statuses of vehicles 10, personnel via PPE 100, equipment, and other actions on the jobsite. By way of example, the vehicles 10 may provide sensor data and the PPE 100 may provide sensor data from the sensors 112 to a remote device 205 for storage and/or analysis. Based on the available data, the remote device 205 may generate assignments for vehicles 10, personnel, and equipment. The remote device 205 may also integrate with outside networks or communication systems to provide network form the network at the jobsite to the internet or other devices.

The PPE 100 may be connected to one or more user devices 210 (e.g., smartphones, tablets, laptops, desktop computers, etc.). The user devices 210 may facilitate a user monitoring and/or controlling operation of the PPE 100. By way of example, the user devices 210 may indicate statuses (e.g., health status, position, presence, etc.) of the various PPE 100 and other vehicles 10 or other PPE 215 on the jobsite. By way of example, the user devices 210 may receive alerts from the PPE 100, for example biometric data from a PPE 100 indicating a wearer is experiencing a health issue (i.e., heat stroke, heat exhaustion, dehydration, heart attack, etc.) or if an obstacle is about to hit the wearer and wear the obstacle is coming from. The alerts can be audible, visual, physical (e.g., vibration) or text-based alerts. The PPE 100 may also provide alerts or information to the other devices (e.g., vehicle 10, remote device 205, user devices 210 other PPE 215, etc.) based on any of the sensed data from the sensors 112 the directly monitored or derived values therefrom. This can include the health, position, direction of movement, height, proximity to one or more vehicles 10, association of a PPE 100 with a vehicle 10, etc. The association of the PPE 100 with the vehicle 10 may occur in response to an action (e.g., scanning a barcode initiating the association, etc.) or by identifying a profile/unique identifier of the PPE 100 and/or the wearer of the PPE 100 indicating that the user has permission to use the vehicle 10. In some embodiments, the user devices 210 may also provide data including commands to the PPE 100. For example, a user of the user devices 210 may provide a request to identify a specific worker on a jobsite, and the user devices 210 can send a command to the PPE 100 associated with the specific worker to activate one or more components of the PPE 100 such as lights or speakers of the user interface 114. In some embodiments, the 210 can receive data from multiple connected PPE devices, including PPE 100 and other additional PPE 215.

In some embodiments, a PPE 100 may be associated with one or more vehicles 10, remote device 205, or user devices 210 based on an identifier (e.g., a unique identifier, an identification number, a name, a barcode, etc.) of the PPE 100. Specifically, each PPE 100, vehicle 10, remote device 205, and/or user device 210 may be assigned or otherwise associated with one or more identifiers. The identifier may uniquely identify a corresponding device. By way of example, the identifier may designate a particular helmet as “PPE Number 111”. Alternatively, the identifier may correspond to a user, individual, or wearer with whom the device is associated. By way of example, a helmet and a vehicle 10 may each be associated with an identifier “User Number 753” corresponding to a user that is assigned that particular helmet and vehicle 10. Accordingly, an identifier may be shared by multiple devices (e.g., if a corresponding user is associated with more than one device in a system). Additionally, one device may be associated with multiple different identifiers (e.g., if multiple users are known to operate the same vehicle 10, such as in a pilot/copilot configuration or for different shifts). The identifiers and corresponding associations (e.g., determined based on at least the identifiers, etc.) may be stored locally (e.g., onboard each device) and/or remotely (e.g., a PPE 100 may request from a remote device 205 or a remote server which other devices are associated with an identifier of a particular user). In some embodiments, the vehicle 10 may be assigned or be associated with a vehicle identifier. In some embodiments, at least a portion of the vehicle identifier may match or be associated with at least one of the unique identifier of the PPE 100 or the unique identifier of the user indicating that the PPE 100 is compatible with the vehicle 10 or that the user is authorized to operate the vehicle 10.

The identifier may be based on or associated with a wearer of the PPE 100. For example, the identifier may be associated with a profile of the wearer of the PPE 100. In some embodiments, the PPE 100 includes a predetermined identifier. In other embodiments, the PPE 100 is assigned by a user when using the PPE 100 (e.g., via an app on the user devices 210, for example). The identifier associated with the PPE 100 may determine which other devices on the network the PPE 100 couples to. For example, a specific worker may be assigned to a specific vehicle 10. The vehicle 10 may therefore be assigned or associated with the identifier of that worker. The PPE 100 may thereafter determine that the vehicle 10 shares the same identifier as the PPE 100, such that the PPE 100 can share data or information with the vehicle 10, and receive data and information from the vehicle 10. In such embodiments, the PPE 100 is associated with a specific one of a plurality of vehicles 10 based on the identity of the wearer. For example, this can allow a vehicle 10 to respond to and interact with the presence or proximity of the appropriate PPE 100 and not another PPE 100 associated with a different wearer. For example, a vehicle 10 may perform one or more actions (e.g., turn on climate control system, turn on lights, start engine, etc.) based on the presence of a PPE 100 in a defined distance of the vehicle 10. In some embodiments, the vehicle 10 may perform such actions or other actions based on a command received by a user interacting with the user interface 114 of the PPE 100 (e.g., pressing a button, performing a gesture, speaking a command, etc.).

The PPE 100 may be communicably coupled to one or more tools (e.g., power tools, end effectors, implements, machine accessories, etc.) on a jobsite, shown as tools 220. Similar to the association of the PPE 100 with one or more vehicles 10, a PPE 100 may be associated with one or more tools 220. Similarly this association may be determined based on an action such as scanning a barcode and selecting or causing such association or a via a signal sent from a communication interface of one of the PPE 100 or the tool 220. Such association may serve as a form of access control to ensure that only the appropriately permitted, trained, or otherwise approved users associated with the PPE 100 can use the tools 220. For example, a tool 220 may not operate or function unless a user wearing a PPE 100 associated with tool 220 is within a defined distance of the tool 220. In some embodiments, the tool 220 may not operate if the PPE 100 indicates the wearer is experiencing a health issue or is looking in a direction away from the tool 220.

Still with reference to FIG. 2, the PPE 100 may thus communicate with one or more devices or machines across a network, shown as network 225. While shown as a single network 225, it should be understood that multiple networks may be used. For example, the tools 220 may couple to the PPE 100 over a second network 230, for example Bluetooth, while the vehicles 10 may couple to the PPE 100 over the first network 225, for example WiFi. It should be understood that the PPE 100 can communicate over a plurality of networks for sending and receiving such data as described herein. In some embodiments, the network (e.g., first network 225, second network 230) is a mesh network formed between multiple devices of the jobsite 200 (e.g., permitting indirect communication between two devices through a third device). In use, the operation of the vehicle 10, remote device 205, user devices 210 other PPE 215 and tool 220 can be controlled or based on data obtained from the PPE 100 and the PPE 100 can provide alters or information to a user based on information obtained from the vehicle 10, remote device 205, user devices 210, other PPE 215, or tool 220.

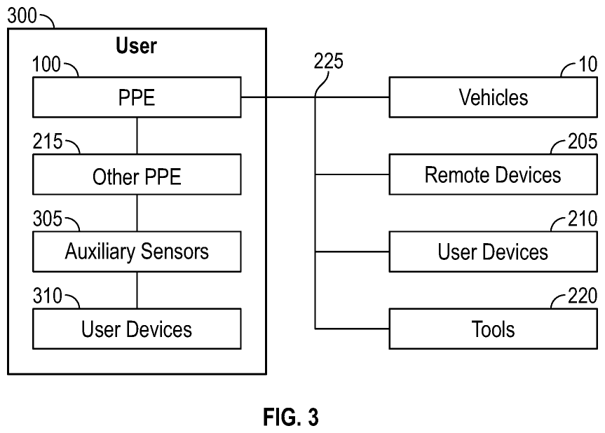

Referring now to FIG. 3, the PPE 100 is shown coupled to a user 300. The user 300 is also shown to be wearing or include other PPE 215, one or more auxiliary sensors 305, and one or more user devices 310. The auxiliary sensors 305 may be one or more sensors similar to those described above with reference to sensors 121, including fall arrest sensors, temperature sensors, heat monitors, GPS receivers, etc. The user device 310 may be one or more devices similar to those described above with reference to user device 210.

The PPE 100 may act as a hub or gateway for connecting other devices (e.g., other PPE 215, one or more auxiliary sensors 305, or one or more user devices 310) to the network 225 and the other devices or equipment on the network. In some embodiments, the other devices (e.g., other PPE 215, one or more auxiliary sensors 305, or one or more user devices 310) may communicate over a first network type (e.g., Bluetooth, NFC, Zibee, WiFi, cellular, etc.) with the PPE 100, and the PPE 100 may communicate with the network 225 over a second network type different than the first. In this way, for example, the PPE 100 can use a cellular connection to provide data from the one or more auxiliary sensors 305 and one or more user devices 310, for example, which may only have a Bluetooth connection. The PPE 100 thus acts as a gateway to the network 225 for the other devices.

In some embodiments, the other devices (e.g., other PPE 215, one or more auxiliary sensors 305, or one or more user devices 310) are assigned an identifier associating the devices with the wearer. In such embodiments, the PPE 100 which may also be associated with the identifier of the wearer, may receive signals from a plurality of other devices (e.g., other PPE 215, one or more auxiliary sensors 305, or one or more user devices 310), but will only pass on data from the other devices which share the same identifier as the PPE 100. In such embodiments, the PPE 100 is able to distinguish between, for example, auxiliary sensors 305 on the wearer of the PPE 100, and auxiliary sensors on a different person (e.g., based on whether the devices share an identifier).

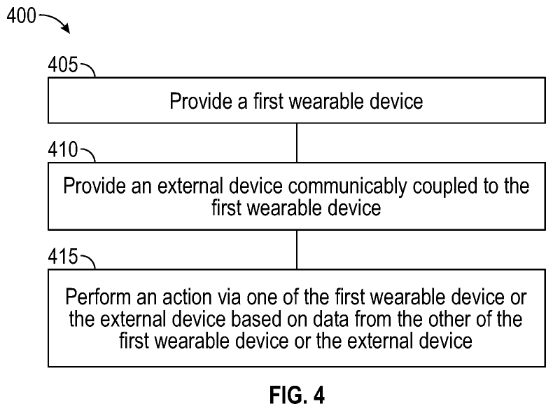

Referring now to FIG. 4, a process 400 for performing an action with or based on data from a wearable device such as PPE 100 is shown. The steps of process 400 may be performed in whole or in part by the controller 102. Step 405 includes providing a first wearable device (e.g., the PPE 100). At step 410, the process 400 includes providing an external device communicably coupled to the first wearable device. In some embodiments, the PPE 100 may be communicably coupled to the external device via the communication interface 108. The external device may be one or more of the vehicle 10, remote device 205, user devices 210, other PPE 215, tools 220, one or more auxiliary sensors 305, or one or more user devices 310. In some embodiments, the PPE 100 is coupled to a plurality of external devices. In some embodiments, the PPE 100 is coupled to external devices across various different networks or network types. For example, the PPE 100 may be coupled to a one or more auxiliary sensors 305 on a Bluetooth network and a vehicle 10 on a cellular network.

At step 415, the process 400 includes performing an action via one of the first wearable device or the external device based on data from the other of the first wearable device or the external device. For example, the PPE 100 or the other devices as described above may perform an action based on a signal associated with the data from the other of the PPE 100 or the other devices. The data may be provided via the signal sent from the communication interface 108. The data may be a status of the wearer of the PPE 100. For example, in some embodiments, the PPE 100 monitors a status of an operator using one or more of the sensors 112. The status can include discrete values such as temperature, blood pressure, heart rate, etc. and/or derived values such as tiredness or stress level. The derived values may be based on one or more of the discrete values and/or external data points such as time, location, etc. In some embodiments, the sensors 112 monitor other aspects such as location, direction of movement, line of sight, speed, height, etc. The PPE 100 may perform an action based on the data (e.g., biometric data, position data, orientation data, etc.).

The action may be or include generating an alert (e.g., audible alert, visual alert, text-based alert, etc.). The action may be generated based on the signal sent by the communication interface 108. The alert may be provided to a wearer of the PPE 100 via the user interface 114, others around the wearer of the PPE 100, and/or the external device coupled to the PPE 100 via the communication interface 108. In some embodiments, the alert is based on one or more measured or monitored values (e.g., heart rate, time, etc.) in relation to a corresponding threshold value.

This may include when the measured or monitored value is below, at, and/or above the corresponding threshold value. For example, the PPE 100 may monitor a temperature of the wearer using a temperature sensor 112 and determine that the wearer is likely experiencing heat stroke based on the measured temperature. For example, the PPE 100 may compare the temperature detected by the sensors 112 to a baseline temperature accessible via a profile of the wearer or stored in the memory 106, and based on the comparison determine that the wearer is likely experiencing heat stroke. In response, the PPE 100 may generate an alert for the wearer via the user interface 114, and/or provide that alert to a third party via the user interface 114.

For another example, the monitored value may be a location of the user, and the threshold may be a distance of the user relative to another location or landmark on a jobsite (e.g., jobsite 200). To continue the example, the threshold may be distance between the PPE 100 and a hazard zone in the jobsite 200. When the PPE 100 determines the wearer is within the distance, the PPE 100 may provide an alert to the wearer of the PPE 100 and/or to others in the hazard zone to be aware of the wearer.

In some embodiments, the action may be a command for operating the PPE 100 or the external device. For example, when the external device is a vehicle 10, the action may include controlling, via a signal (e.g., sent from the communication interface 108, etc.), the vehicle 10 based on the presence or proximity of the PPE 100. Control may include controlling the operation of the systems or subsystems of the vehicles 10 including steering systems, climate control systems, security systems, ignition systems, hydraulic systems, etc. In some embodiments, the action is to cease or stop operation of the external device. For example, when the external device is a tool 220, the action may be to turn off the tool 220 when the PPE 100 indicates the wearer is looking away from the tool 220. It should be understood that the action may be performed by the PPE 100 (e.g., turning on one or more lights of user interface 114, activating cooling system 116, etc.) or the external device based on data from the other of the PPE 100 or the external device. In other embodiments however the PPE 100 may also perform actions based on data collected by the PPE 100.

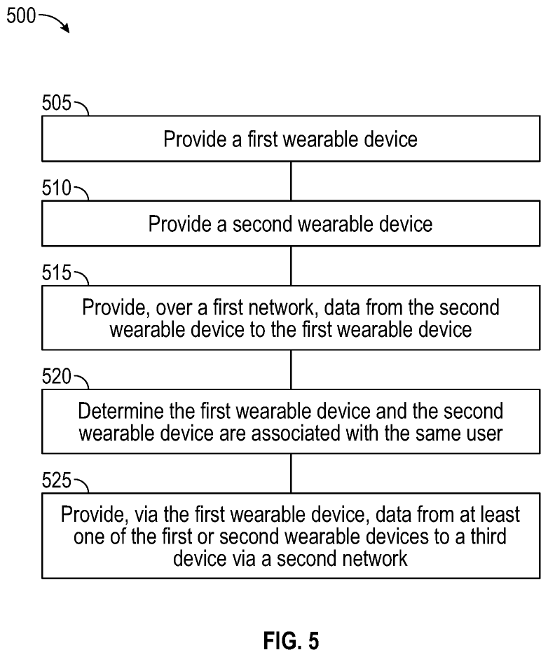

Referring now to FIG. 5, a process 500 for a first wearable device acting as a hub for other wearable devices is shown, according to an exemplary embodiment. The process 500 may be performed in whole or in part by the controller 102 of the PPE 100.

At step 505 a first wearable device is provided. The first wearable device may be the PPE 100. At step 510, a second wearable device is provided. The second wearable device may be other PPE 215, one or more auxiliary sensors 305, and/or one or more user devices 310. At step 515, data from the second wearable device is provided over a first network to the first wearable device. The first network may be a first type of network (e.g., Bluetooth, WiFi, cellular, etc.).

The data may include information or data identifying the second device and/or a wearer associated with the second device. At step 520, the process 500 includes determining the first wearable device and the second wearable device are associated with the same user. In some embodiments, this includes determining if an identifier associated with the second wearable device is the same as the identifier associated with the first wearable device. The identifier may be an identifier corresponding to a wearer of the first wearable device and the second wearable device. At step 525 the process 500 includes provide, via the first wearable device, data from at least one of the first wearable device or the second wearable device to a third device via second network. The third device may be, for example, the vehicle 10, remote device 205, user devices 210, other PPE 215 or tool 220 as shown in FIG. 2. In some embodiments, the second network is of the same network type as the first network. In other embodiments, the second network is a different network type. For example, the second network may be a long-range network (e.g., WiFi, cellular, satellite, etc.) while the first network may be a short-range network (e.g., Bluetooth, NFC, etc.) In this way, the first wearable device (e.g., PPE 100) can act as a hub or gateway for the second wearable device to access the second network.

### Jobsite Monitoring

The PPE 100 may facilitate more accurate and improved jobsite monitoring capabilities. When used in combination with one or more vehicles 10, a control system (e.g., controller 102, vehicles vehicle 10, remote device 205, user devices 210, etc.) can obtain a more accurate picture of jobsite for site wide monitoring and control. This may include operator location information, vehicle location information, operator compliance with PPE rules, general jobsite access control, and other jobsite tasks. The data from the PPE 100 can also be used in conjunction with or to supplement the data already provided by or available to one or more vehicles 10.

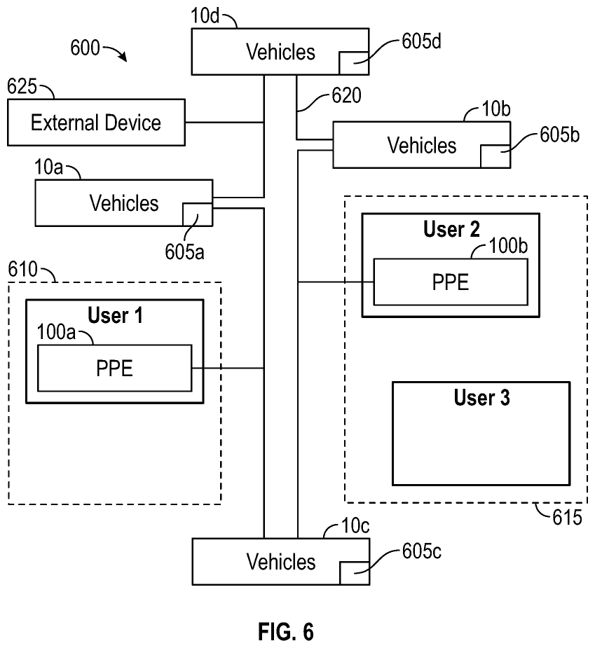

For example, referring now to FIG. 6, each of the vehicles 10 (e.g., vehicles 10a, 10b, 10c, 10d) include a camera-based vision system shown as cameras 605 (e.g., 605a, 605b, 605c, 605d). The camera-based vision system can permit the vehicles 10 to monitor the environment around the vehicle. The cameras 605 may include a distance sensor, such as a RADAR. In some embodiments, the cameras may be visible spectrum cameras (e.g., an RGB camera). In other embodiments, the cameras 605 may be infrared (e.g., short-wave infrared) cameras or thermal imaging cameras. In some embodiments, the distance sensor may be a LiDAR or an ultrasonic sensor. The cameras 605 may thus include any type of distance, proximity, image, and/or object sensors, such as one or more light curtain sensors, ultrasonic sensors, laser sensors, visible light cameras, full-spectrum cameras, light detection and ranging (LIDAR) cameras/sensors, radar sensors, infrared cameras, image sensors (e.g., charged-coupled device (CCD), complementary metal oxide semiconductor (CMOS) sensors, etc.), or any other type of suitable distance sensor, proximity sensor, or imaging device. In some embodiments, the vehicle 10 may include more than one camera and/or more than one distance sensor. The cameras and the distance sensors may be arranged facing outward from the vehicle 10 in one or a plurality of directions.

The cameras may facilitate autonomous control and navigation of the vehicles 10 throughout the jobsite 600. Data captured or acquired by the cameras 605 may be used (e.g., by the vehicle 10, the PPE 100, the remote device 205, the user devices 210) to characterize the jobsite, including the number of people on the jobsite, the number of machines, the number of PPE 100, and other determinations.

In some embodiments, the PPE 100 may be used in combination with the vehicle 10 to monitor the jobsite for compliance with PPE or access rules. For example, the vehicle 10 (e.g., using the cameras 605) and/or the PPE 100 (e.g., using the sensors 112) can identify how many people on the jobsite are without appropriate PPE (e.g., connected PPE such as PPE 100) by using image processing techniques, deep neural processing, tensor processing, machine learning, etc. to detect people without PPE. By way of example, processing circuitry (e.g., of a remote device 205) may first identify one or more people within a captured image. The processing circuity may then analyze each person to determine whether a required PPE is visible in a location associated with proper use of the PPE (e.g., checking the location of the person's head for a helmet, checking the location of a person's chest for a vest, etc.). An identified person may be considered to not be wearing PPE if the required PPE is not detected in the expected location (e.g., a person carrying a helmet is considered not to be wearing PPE if a helmet is required to be worn on a head of the person in that zone or area, etc.). The number of people detected without PPE can be compared to the number of PPE 100 detected at the site. In some embodiments, the image-based system can further determine who is wearing PPE but not the smart or connected PPE such as PPE 100. By way of example, the system may compare the number of people detected wearing PPE with the number of PPE 100 in communication with the system and currently identified as being worn by a user (e.g., due to sensed movement of the PPE). In such cases, the system can more accurately determine the number of people without PPE versus just a count of the number of PPE 100 at a site.

In some embodiments, the number of PPE 100 detected at a jobsite (e.g., by providing a signal to the vehicles 10, or the PPE 100 otherwise being sensed) may be compared to the number of vehicles 10 at the jobsite. For example, there may be determined to be four vehicles at a jobsite but only two PPE 100. In such cases, if more than two vehicles 10 are in operation, the jobsite manager may know (via remote device 205, user devices 210, vehicle 10, etc.) that vehicles 10 are being operated by operators without the proper PPE. Such vehicles can be identified (e.g., by lights, alarms, etc.) based on signals or commands provided to them across the network. In some embodiment, such vehicles may also be disabled or otherwise controlled.

The vehicles may be identified by identifying which vehicles are near PPE 100, and those not being near PPE 100 are the vehicles being operated by operators without PPE 100. By way of example, the system may review the data from each vehicle 10 to determine which vehicles 10 are in operation (e.g., which vehicles 10 are sensed to be moving or a motor of the vehicle 10 are started). The system may then determine the locations of those vehicles and the locations of PPE 100. If a vehicle 10 is operating while more than a threshold distance from a PPE 100, the system may provide an alert (e.g., to a remote device, to a remote server or network, to other vehicles 10, to other PPE 100, etc.) identifying that vehicle 10.

In some embodiments, the jobsite monitoring can include establishing and maintaining different zones in a jobsite. A jobsite may include no zones, a single zone, or a plurality of zones. The zones may be established manually (e.g., via PPE 100, remote device 205, user devices 210, etc.) or automatically. For example, a zone may automatically be established a predetermined distance around each vehicle 10. For another example, a zone may be automatically established based on path of an overhead load or a moving vehicle 10. The zones may thus indicate potential hazards, dangers, or conditions present in the zones. The conditions can include dangerous zones, high voltage areas, heavy load areas, high traffic areas, areas with a load overhead, the paths of moving equipment such as vehicle 10, a general safety awareness zone, or another type of condition. For example, referring to FIG. 6, jobsite 600 includes a high voltage zone 610 zone 610 and a heavy load zone 615.

The zones may be established by one or more of the PPE 100 and or vehicle 10 in the jobsite 600. In some embodiments, each zone, whether established manually or automatically, is passed to other devices (e.g., PPE 100, vehicle 10, or external device 625) on the network 620. The network 620 may be the same or similar to the network 225, and may in some embodiments be a local area network established by the vehicles 10. The external device may be the same or similar to the remote device 205, user devices 210, or other PPE 215. In some embodiments, each PPE 100 and/or vehicle 10 is thus aware of the location and purpose of the zones such as zone 610. 715.

In some embodiments, the PPE 100 can provide alerts to a user based on their position relative the zones (e.g., zones 610, 615). The alerts can be visual, auditory, vibratory, or another type of alert to the wearer of the PPE 100. For example, the alerts can include flashing lights, alarms, etc. In some embodiments where the PPE 100 includes heads up displays or augmented reality systems as part of the user interface 114, the zones may be represented by visual overlays on the environment for the wearer to see. The alerts may also be intended for those around the PPE 100. For example, the PPE 100 may include a light, and when the PPE 100 passes into a high traffic zone the PPE 100 may flash or pulse the light to improve the visibility of PPE 100 to vehicles and other operators in the high traffic zone.

The alerts can indicate the zone location, the zone purpose, and recommended precautions or actions to take. For example the alerts can indicate an alert of a load ahead, or a suggestion to move (e.g., tread, walk, etc.) slowly, or to avoid an area, etc.

The alerts may be triggered when a user is a predetermined distance from a zone. In some embodiments, the alerts are triggered when a PPE 100 crosses into a zone. In some embodiments, an alert is triggered when a new zone is established within a predetermined distance from the PPE 100.

The location of the PPE 100 may be determined using a BLE (e.g., BLE 5.2) which allows for dead reckoning and location determination within a certain area. In some embodiments, the location or position of the PPE 100, and thereby the wearer of the PPE 100, can only be determined within a certain amount of precision (e.g., within 5 ft, within 1 ft, etc.). In such cases, the alert may be triggered based on the outermost possible position, to minimize the possibility of the wearer entering an undesirable area.

In some embodiments, one or more actions are triggered based on the proximity of the PPE 100 relative to the one or more zones. The actions may include the control of vehicles 10 within the zone. For example, if a PPE 100 passes into a high traffic zone, the vehicles 10 within the high traffic zone may receive a command to slow to a reduced maximum speed or to stop. In some embodiments, the action may include directing a device (e.g., vehicle 10, tool 220, etc.) to cease operation while PPE 100 is detected within the zone. In other embodiments, the action will not be triggered until a number of PPE 100 detected within a zone exceeds a predetermined threshold. In other embodiments, the action may only be triggered (or may not be triggered) based on the identifier associated with the PPE 100 in or near the zone. For example, if an identifier associated with an inspector or other individual predetermined as being approved to work with high-voltage electricity is detected within a high voltage zone, the one or more devices in the high voltage zone may be deactivated due to the increased likelihood of the that individual working with the high-voltage electricity. The system may not deactivate the devices for another individual that is identified as not being permitted or assigned to work with high-voltage electricity, as such individuals may be less likely to interact with the high-voltage devices.

In some embodiments, the PPE 100 can act as a general jobsite access control system. For example, in embodiments where each PPE 100 is associated with a unique identifier, the PPE 100 can act as an access credential for the wearer to enter the site or to access facilities on the site such as tool trailers, offices, etc. By way of example, the system may determine a predetermined list of identifiers having access to a particular area. The system may lock or unlock a door based on a PPE 100 having one of the predetermined identifiers passing within a predetermined distance of the area. In some embodiments, the total count of PPE 100 on the site can be compared to an expected count to determine absences or unexpected people who are present. In some embodiments, the total number of PPE 100 can be compared to the total number of people otherwise detected by the vehicle 10 (e.g., using cameras 605) for monitoring and control purposes.

### Machine Access and Control

The PPE 100 can interact with the vehicle 10 to perform a variety of machine access and control functions. In such embodiments, the PPE 100 may be connected or communicably coupled to the vehicle 10 on a network via the communication interface 108. The network may be a local area network such as a mesh network established at least in part by the vehicle 10. The network may also be another type of network as described herein.

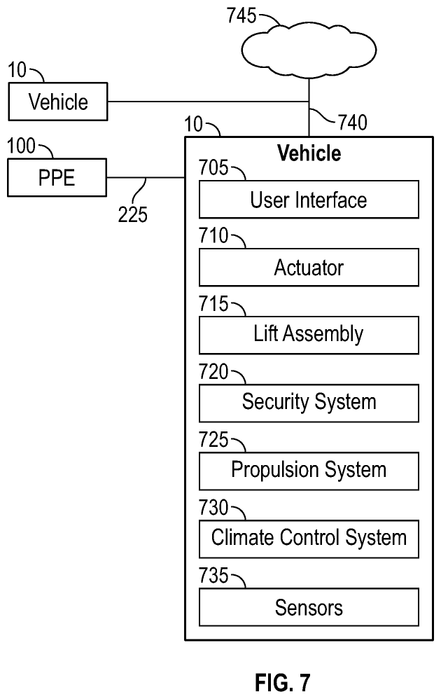

Referring now to FIG. 7, in some embodiments, the PPE 100 can direct or cause the vehicle 10 to perform one or more actions as part of a machine wake up operation. The vehicle 10 includes a number of systems, subsystems, or components, which may be a part of the wake up operation. The vehicle 10 includes a user interface 705, which may be the same or contain components similar to the user interface 114. The vehicle 10 includes an actuator 710. The actuator 710 may move or adjust one or more other components of the vehicle 10. The vehicle 10 includes a lift assembly 715. The lift assembly 715 may be a boom lift, a scissor lift, or another type of lift assembly. The vehicle 10 includes a security system 720. The security system 720 may include proximity sensors, alarms, locks, cameras, or other devices for monitoring the vehicle 10. The vehicle 10 may include a propulsion system 725. The propulsion system 725 may include an engine or motor and one or more tractive elements (e.g., wheels, tracks, etc.) for propelling, steering, or otherwise moving the vehicle 10. The vehicle 10 may include a climate control system 730. The climate control system 730 may include fans, condensers, expanders, heat exchangers, misters, etc. for controlling or adjusting a climate in the vehicle 10 in embodiments where the vehicle 10 has a cab or cabin. The vehicle 10 includes one or more other sensors 735 which may be the same or similar to the sensors 112.

The actions of the wake up operation may prepare a machine for operation by a wearer of the PPE 100. In some embodiments, the machine wake up operation (e.g., start-up operation, engagement operation, etc.) is triggered based on data (e.g., information, messages, commands, etc.) received from the PPE 100 (e.g., via a signal sent from the communication interface 108, etc.). In some embodiments, the data is obtained at least in part by the sensors 112. The data may be an indication that a user is assigned to operate the vehicle 10. For example, in some embodiments each of the PPE 100 and the vehicle 10 may be associated with the same user or operator. In some embodiments, the association is done (e.g. selected via a user input, etc.) via a third device (e.g., remote device 205, user devices 210, other PPE 215, etc.). In response to the association, the vehicle 10 may filter data or commands from a plurality of PPE 100 to only respond to those to the PPE 100 associated with the same identifier. In some embodiments, the data indicates a proximity of the PPE 100, and thereby the wearer, to the vehicle. The proximity may be determined by the sensors 112 of the PPE 100 alone or in combination with the sensors 735 of the vehicle 10.

In response to the data indicating the vehicle 10 should wake up, the vehicle 10 may automatically perform one or more actions. The one or more actions may operate or control the vehicle 10. In some embodiments, the one or more actions include the machine operating one or more lights (e.g., part of user interface 705 or headlights or other lights of the vehicle 10). In some embodiments, the vehicle 10 may activate, flash, or pulse the lights. The light control may allow the wearer of the PPE 100 to identify the vehicle 10 associated with the wearer from a plurality of vehicles 10 that may be present at the jobsite. In this way, a jobsite manager can quickly and efficiently assign vehicles 10 to operators, and the operators may then quickly proceed to the proper vehicle. The color, brightness, flashing rate, and other characteristics of the lights can be adjusted to facilitate the operator differentiating between different vehicles 10. The vehicle 10 may additionally and/or alternatively provide other indications including sounds or movement of the vehicle 10 itself to help guide a user to the vehicle 10.

In some embodiments, the vehicles 10 can activate or start a propulsion system 725 of the vehicle 10 in response to the data. This may include starting an engine or motor of the vehicle to prepare the vehicle for operation or move the vehicle 10. In some embodiments, the vehicle 10 can activate or configure a climate control system 730 of the vehicle 10. This can allow the vehicle 10 to prepare a cabin of the vehicle 10 for the operator such as by preheating or cooling a cabin. In some embodiments, this includes configuring the climate control system 730 according to a profile of the wearer of the PPE 100.

In embodiments with a plurality of vehicles 10 and a plurality of operators with PPE 100, the PPE 100 and the vehicles 10 may communicate to vary or adjust one or more aspects of the wake up operation to ensure each operator can go to the appropriate vehicle. For example, the vehicles 10 may each flash one or more lights of a different color, and the associated PPE 100 for each vehicle 10 will also flash a light of the same color for the wearer, such that multiple operators can proceed to multiple machines without confusion. The light color, flashing rate, brightness, can all be changed. In addition, the PPE 100 can provide other audible or visual indications to help an operator identify which vehicle 10 of a plurality of vehicles 10 to move to. This can include a beeping tone which increases in frequency as the operator nears the vehicle 10, a natural language instruction for which vehicle 10 to approach, a visual overlay, for example in an augmented reality display, of around the appropriate vehicle 10, and/or other aspects to help an operator identify the appropriate vehicle.

Still referring to FIG. 7, in some embodiments, the PPE 100 can direct or cause the vehicles 10 to perform one or more actions as part of a machine access or control operation. The PPE 100 can thus act as a smart access control to allow operation of the vehicle 10 only by an authorized user, who is wearing the correct PPE 100. As described herein, each of the PPE 100 and the vehicle 10 can be associated with a unique identifier. In some embodiments, there are a plurality of unique identifiers, and the PPE 100 and vehicle 10 are associated with one identifier of the plurality. The identifiers can be set using the PPE 100, the vehicle 10 or another device (e.g., remote device 205).

The machine access or control operation may be triggered by a proximity of the PPE 100 to the vehicle 10, a command from the PPE 100, a password or access code provided to the vehicle 10, or another trigger condition. For example, the vehicle 10 may sense a number of PPE 100 are in an area around the vehicle 10. In some embodiments, the vehicle 10 may not perform an action to provide access or control until the PPE 100 associated with the identifier of the vehicle 10 is within in a predetermined distance. This may be determined by data from the PPE 100 and/or the vehicle 10. In some embodiments, the vehicle 10 will not perform the actions or provide control until the PPE 100 associated with the right identifier is the nearest PPE 100. In some embodiments, the user of the PPE 100 may interact with the user interface 114 to input a command to being the machine access or control actions. For example, a user may say “unlock” (e.g., provide a voice input, etc.), which may be heard by the user interface 114 and processed as a command thereby provided to the vehicle 10. The vehicle 10, determining the command is provided by a PPE 100 associated with the same identifier as the vehicle 10, may thereby perform the action. In some embodiments, the PPE 100 may provide a code to the wearer (e.g., a pin, password, etc.) which the user may input into the vehicle 10 to perform one or more actions. For example, the PPE 100 may display a pin to the user which the user may input into the vehicle 10 to unlock the vehicle 10.

In some embodiments, the actions can include activation or operation of the security system 720. For example, in response to data triggering the action, the vehicle 10 can control the security system 720 to unlock the doors of the vehicle 10 to provide to operator access. In some embodiments, if the vehicle 10 includes a plurality of controlled access doors or panels, the vehicle 10 can sequentially unlock one or more of the plurality of controlled access doors. For example, if an operator is required to check a fuel level before operating the vehicle 10, the vehicle 10, in response to the data, may unlock an oil access panel and only after unlock a cabin door. The machine wake up actions can include control of the any of the components, systems, or subsystems of the 10 (e.g., the user interface 705, actuator 710, lift assembly 715, security system 720, propulsion system 725, climate control system 730, and/or one or more other sensors 735.

In some embodiments, the identifier associated with the operator and the vehicle 10 is also associated with a profile for the operator. The vehicle 10 may obtain the profile either from local memory or from an external device (e.g., remote device 205, cloud 745) and perform the machine wake up process according to the profile. The profile may thereafter be stored locally. The profile can change the order of operation of the machine wake up operation, or the values within it such as cabin temperatures, fan speeds, seat height, etc. The vehicle 10 may also operate according to the profile associated with the identifier. For example, the machine control response, haptic feedback levels, user interface control mapping, joystick inversion settings, speeds of movement, etc. may be set based on data in the profile indicating the user preference.

In some embodiments, the functionality of the vehicle 10 is limited based on the identifier associated with the machine. This can include limiting the working envelope of the vehicle 10, where the vehicle 10 can be driven to, what accessories or end effectors the vehicle 10 can be used with, etc. In some embodiments, the functionality can be expanded (e.g., in response to payment) and the additional functions or features unlocked for the user's identifier.

The vehicle 10 may act as a gateway for the PPE 100 to access additional networks, such as the cloud 745. The cloud 745 may be a remote server, database, computing system, or the general world wide web. In some embodiments, upon establishing communication with the PPE 100, the PPE 100 may pass all communications and data transfers through the vehicle 10. In some embodiments, the PPE 100 and the vehicle 10 establish an internal local mesh network. In some embodiments, the vehicle 10 has a communication interface which has more range or capacity than the PPE 100, such that by the vehicle 10 acting as a hub (e.g., a communication intermediary that passes data between two other devices) for the PPE 100, the communication capability of the PPE 100 is greatly expanded. The combination of the PPE 100 and the vehicle 10 may thus interact with the network (e.g., network 740) as a single combined unit. In such cases the PPE 100 may access the cloud 745 through the vehicle 10.

In some embodiments, the PPE 100 can provide a physical indicator (e.g., visual, auditory, etc.) to communicate with the vehicle 10. Visual indicators may include lights, symbols, colored sections, reflective sections, etc. For example, the PPE 100 may include a light as part of the user interface 114 and may flash the light. The vehicle 10, using the one or more other sensors 735 (e.g., vehicle sensors, etc.) may detect the light and thereby determine the location of the PPE 100. By way of example, the vehicle 10 may utilize image data from a camera and identify a light within field of view of the image data. A controller may review the image data and search for a flashing pattern or light wavelength corresponding to the pattern emitted by the light of the desired PPE 100. Based on a known position of the camera and the position of the light within the image data, the controller may determine the position of the identified PPE 100. In this way the vehicle 10 can track the location of users of PPE 100 at a jobsite. In some embodiments, the light may be visible light or infrared light. In other embodiments the PPE 100 may emit a sound detected by the vehicle 10. By way of example, the system may perform a similar process using a microphone to identify emitted sound of a particular frequency or pattern instead of a camera. In some embodiments, multiple machines on the network 740 (which may be the similar to networks 225, 230) may monitor for PPE 100 and provide the locations of the PPE 100 to the network 740 for jobsite wide tracking. In this way, the PPE 100 can improve the tracking or machine vision capabilities of the vehicle 10 by making it easier to identify people.

### Vehicle

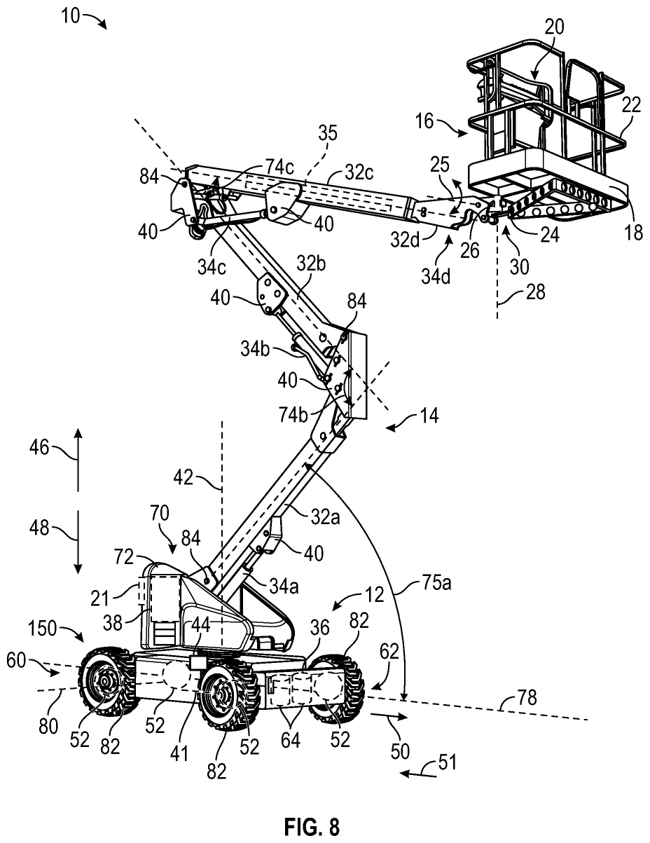

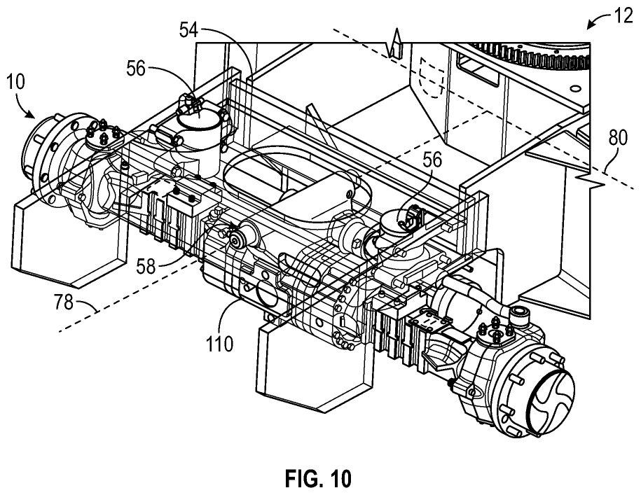

Referring to FIG. 8, a vehicle, a lifting apparatus, lift device, or mobile elevating work platform (MEWP) (e.g., a telehandler, an electric boom lift, a towable boom lift, a lift device, a fully electric boom lift, etc.) is shown as vehicle 10. The vehicle 10 may communicate with the PPE 100 such that the vehicle 10 receives and/or provides commands to/from the PPE 100. The commands provided to the vehicle 10 can include to operate one or more components, systems, or subsystems of the vehicle 10. Additionally, while vehicle 10 is shown as a lift device in FIGS. 8-11, it should be understood that vehicle 10 may also be other vehicles such as scissor lifts, telehandlers, trucks, refuse trucks, mixer trucks, fire fighting trucks, passenger vehicles, cargo trucks, etc.

The vehicle 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The vehicle 10 includes a front end (e.g., a forward-facing end, a front portion, a front, etc.), shown as front 62, and a rear end (e.g., a rearward facing end, a back portion, a back, a rear, etc.), shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of vehicle 10 and the rearward direction 51. The vehicle 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the vehicle 10. The tractive elements 82 can each include an electric motor 52 (e.g., electric wheel motors) configured to drive the tractive elements 82 (e.g., to rotate tractive elements 82 to facilitate motion of the vehicle 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the vehicle 10. In some embodiments, the electric motors 52 are optional, and the tractive elements 82 are powered or driven by an internal combustion engine.

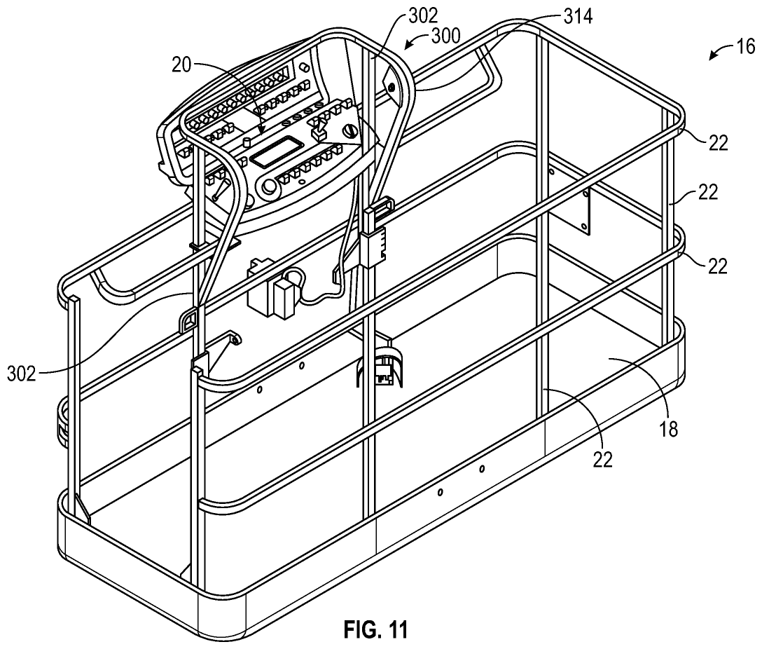

With additional reference to FIG. 11, the platform assembly 16 is shown in further detail. The platform assembly 16 is configured to provide a work area for an operator of the vehicle 10 to stand/rest upon. The platform assembly 16 can be pivotally coupled to an upper end of the lift assembly 14. The vehicle 10 is configured to facilitate the operator accessing various elevated areas (e.g., lights, platforms, the sides of buildings, building scaffolding, trees, power lines, etc.). The vehicle 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the vehicle 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the vehicle 10 to grasp while using the vehicle 10 (e.g., to grasp while operating the vehicle 10 to elevate the platform assembly 16). The rails 22 can include members that are substantially horizontal to the deck 18. The rails 22 can also include vertical structural members 23 that couple with the substantially horizontal members. The vertical structural members 23 can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the vehicle 10. The user interface 20 can include any number of buttons, levers, switches, keys, etc., or any other user input device configured to receive a user input to operate the vehicle 10. The user interface 20 may also provide information to the user (e.g., through one or more displays, lights, speakers, haptic feedback devices, etc.). The user interface 20 can be supported by one or more of the rails 22.

Referring to FIG. 8, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The vehicle 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the vehicle 10. The intermediate lift arm 32d may extend into an inner volume of the upper lift arm 32c and extend and/or retract. The lower lift arm 32a and the medial lift arm 32b may be referred to as “the boom” of the overall vehicle 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32 a and the medial lift arm 32b and facilitate elevating of the platform assembly 16.

Similarly, the actuator 34 b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

Referring to FIGS. 7 and 8, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the vehicle 10. The batteries 64 can be stored within the base 36. The vehicle 10 includes a controller 38 that is configured to operate any of the motors, actuators, etc., of the vehicle 10. The controller 38 can be configured to receive sensory input information from various sensors of the vehicle 10, user inputs from the user interface 20 (or any other user input device such as a key-start or a push-button start), etc. The controller 38 can be configured to generate control signals for the various motors, actuators, etc., of the vehicle 10 to operate any of the motors, actuators, electrically powered movers, etc., of the vehicle 10. The batteries 64 are configured to power any of the motors, sensors, actuators, electric linear actuators, electrical devices, electrical movers, stepper motors, etc., of the vehicle 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the vehicle 10.

The batteries 64 are configured to deliver power to the motors 52 to drive the tractive elements 82. A rear set of tractive elements 82 can be configured to pivot to steer the vehicle 10. In other embodiments, a front set of tractive elements 82 are configured to pivot to steer the vehicle 10. In still other embodiments, both the front and the rear set of tractive elements 82 are configured to pivot (e.g., independently) to steer the vehicle 10. In some examples, the base assembly 12 includes a steering system 150. The steering system 150 is configured to drive tractive elements 82 to pivot for a turn of the vehicle 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the vehicle 10 as described herein is described with reference to batteries, electric motors, etc., the vehicle 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

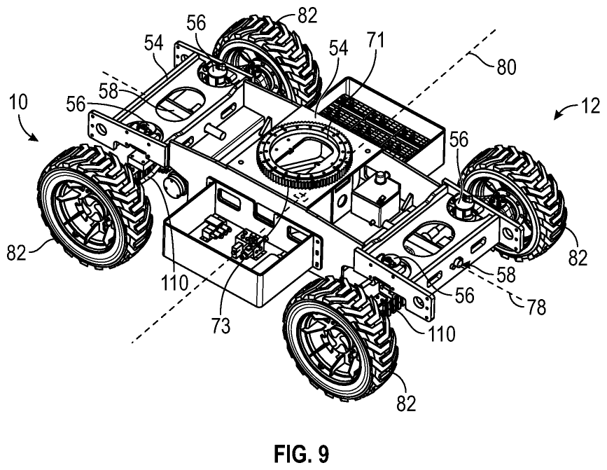

Referring now to FIGS. 8 and 9, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 29 (e.g., axles, frame members, beams, bars, etc.) at opposite longitudinal ends of the longitudinally extending frame member 54. For example, the lateral frame members 29 may be pivotally coupled with the longitudinally extending frame member 54 at a front end and a rear end of the longitudinally extending frame member 54. The lateral frame members 29 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 29 (e.g., a front lateral frame member 29 or a rear lateral frame member 29) or the longitudinally extending frame member 54 and the receiving portion is coupled to the other of the longitudinally extending frame member 54 and the lateral frame member 29. For example, the pin may be coupled with longitudinally extending frame member 54 and the receiving portion can be coupled with one of the lateral frame members 29 (e.g., integrally formed with the front lateral frame member 29).

In some embodiments, the longitudinally extending frame member 54 and the lateral frame members 29 are integrally formed or coupled (e.g., fastened, welded, riveted, etc.) to define the base 36. In still other embodiments, the base 36 is integrally formed with the longitudinally extending frame member 54 and/or the lateral frame members 29. In still other embodiments, the base 36 is coupled with the longitudinally extending frame member 54 and/or the lateral frame members 29.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 29. When the axle actuators 56 extend, an end of a rod of the levelling actuators can contact the surface of lateral frame member 29 and prevent relative rotation between lateral frame member 29 and longitudinally extending frame member 54. In this way, the relative rotation/pivoting between the lateral frame member 29 and the longitudinally extending frame member 54 can be locked (e.g., to prevent rolling of the longitudinally extending frame member 54 relative to the lateral frame members 29 during operation of the lift assembly 14). The axle actuators 56 can receive power from the batteries 64, which can allow the axle actuators 56 to extend or retract. The axle actuators 56 receive control signals from controller 38.

### User Device

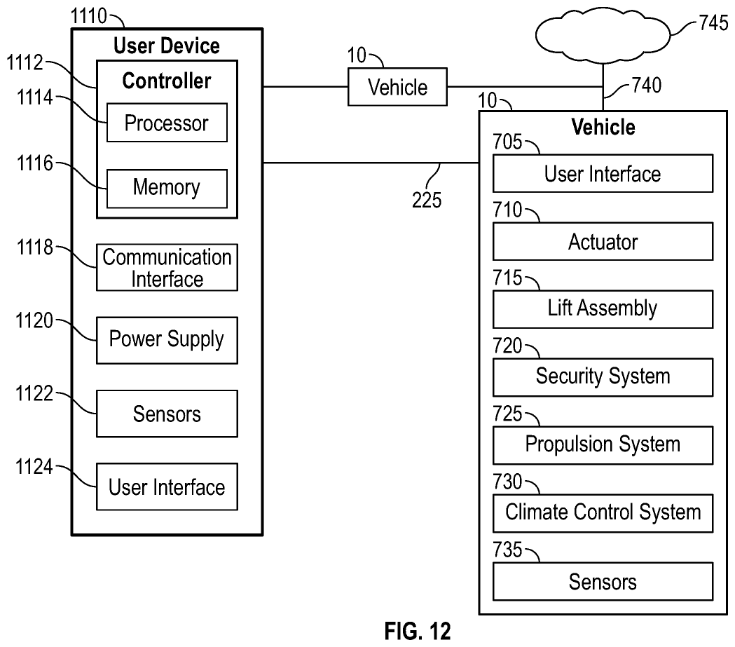

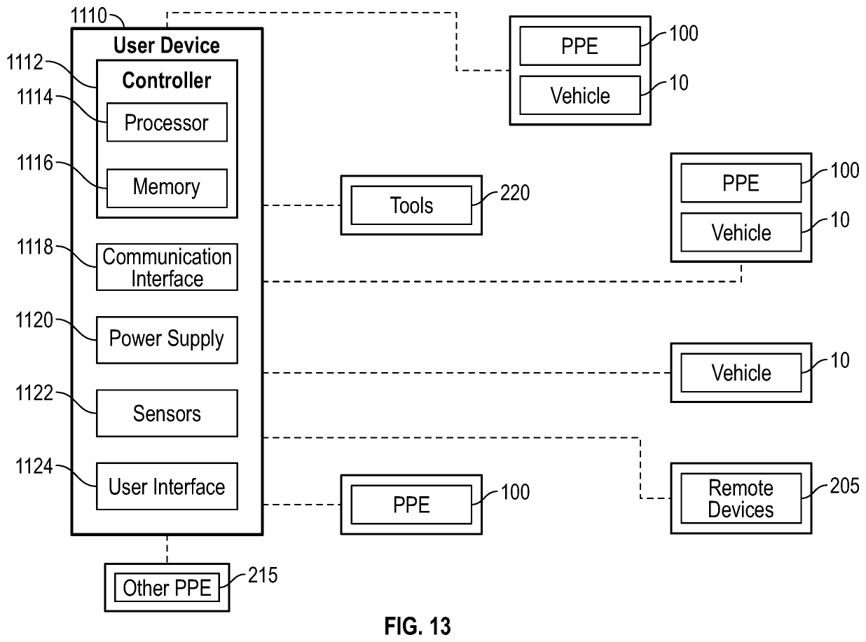

Referring to FIGS. 12 and 13, a vehicle system 1100 is shown including a user device such as a tablet, a display, a smartphone, or a portable device, shown as user device 1110, according to an exemplary embodiment. The user device 1110 may be a portable device that is configured to be synched or connected to a machine or device, such as a vehicle 10, PPE 100, remote device 205, other PPE 215, and/or a tool 220, via the network 225. For example, the user device 1110 is configured to be communicably coupled to synched to any machinery present on a jobsite. The user device 1110 may be coupled to a plurality of vehicles 10 and each of the vehicle 10 may be coupled to the cloud 745. In some embodiments, the user device 1110 may be configured to operate substantially similarly to the user interface 20 as previously described and be portable.

The user device 1110 includes a controller 1112 that controls operation of the user device 1110. The controller 1112 includes a processing circuit, shown as processor 1114, and a memory device, shown as memory 1116. The memory 1116 may contain one or more instructions that, when executed by the processor 1114, cause the processor 1114 to perform the various functions described herein.

The controller 1112 further includes a communication interface 1118 (e.g., a communication circuit, a network interface, etc.) that facilitates communication with (e.g., to and from) other components of the user device 1110. The communication interface 1118 may facilitate wired communication (e.g., through CAN, Ethernet, communication of power, etc.). Additionally or alternatively, the communication interface 1118 may facilitate wireless communication (e.g., through Bluetooth, Wi-Fi, radio transmission, inductive transmission of energy, etc.).

In some embodiments, the communication interface 1118 of the user device 1110 is configured to form a mesh network with other devices of the vehicle system 1100. The user device 1110 is configured to communicate with one or more work machines or vehicles 10 through the mesh network. For example, the user device 1110 may communicate with a first machine, or first vehicle 10, through a second machine, or second vehicle 10. The user device 1110 is also configured to be a communication midpoint or intermediate between one or more machines. For example, the user device 1110 is configured to receive a signal from the first vehicle 10 and provide the signal to the second vehicle 10. In some implementations, the mesh network is formed by the user device 1110 initiating an exchange of networking messages between different work machines (e.g., the vehicle 10, etc.) in the plurality of communicatively connected work machines. In some embodiments, a network node is associated with each work machine in the plurality of networked work machines. In some embodiments, the user device 1110 extends a connection to a first machine or vehicle 10 in proximity to the user device 1110 on a worksite to establish a network link at the worksite. In some embodiments, the user device 1110 may include a worksite network established among a fleet of work machines at the worksite where machines connect with other nearby machines in a mesh network.

The user device 1110 further includes one or more energy storage and/or supply devices, shown as power supply 1120. The power supply 1120 may be or include batteries, capacitors, solar panels, or other types of power supplies. The power supply 1120 may deliver electrical energy to other components of the user device 1110 to power the user device 1110. The power supply 1120 may be charged by an outside source of energy (e.g., an electrical grid, a wireless charging interface, etc.). In some embodiments, the user device 1110 includes another type of power supply such as an AC input for direct connection to the outside source of energy. In yet another embodiment, the power supply 1120 may be a wired connection to a power source (e.g., an outlet).

The user device 1110 includes one or more sensors 1122 operatively coupled to the controller 1112. The sensors 1122 may provide sensor data describing the current status of the user device 1110, the surrounding environment, the PPE 100, a wearer of the PPE, a position or operational state of one or more vehicles 10, a position or operational state of one tools 220, a position or operational state of one or more other PPE 215, and/or operational states of one or more remote device 205. By way of example, the sensors 1122 may include mapping or imaging sensors (e.g., LIDAR sensors, light curtains, cameras, ultrasonic sensors, etc.). The mapping or imaging sensors may map or image the environment around the user device 1110 (e.g., around the jobsite). For example, the sensors 1122 may include cameras for monitoring obstacles and objects around the user device 1110. The sensors 1122 can provide an alert (e.g., vibration, visual alert on a display, an alarm, etc.) indicating a change or update in operational status. By way of example, the sensors 1122 may include position sensors (e.g., GPS, proximity sensors, etc.). By way of example, the sensors 1122 may include orientation or acceleration sensors (e.g., accelerometers, gyroscopic sensors, inertial measurement units, compasses, etc.). The orientation sensors may monitor an orientation or position of the user device 1110 or the person in control of the user device 1110. In some embodiments, the sensors 1122 is configured to determine a position of the user device 1110 relative to one of the machines in the jobsite. For example, the sensors 1122 may receive a signal indicative of a position of the vehicle 10, and based on the signal determine a distance of the vehicle 10 from the user device 1110. In some embodiments, as described further herein, the user device 1110 may be communicably coupled to, or in configured to provide and receive signals with, one of the machines in the jobsite based on a distance of the user device 1110 from the machine.

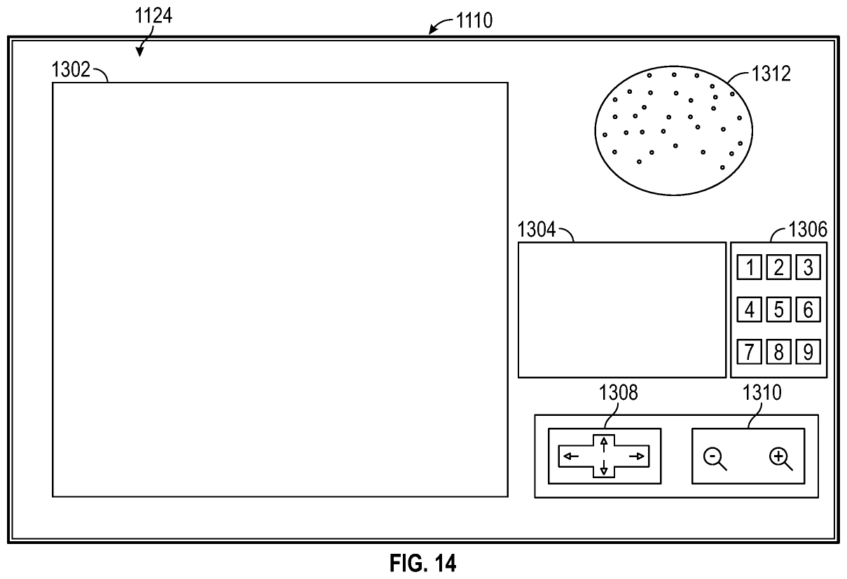

The user device 1110 includes a user interface 1124 (e.g., a HMI, a user interface, keypad, a user input device, a display screen, etc.). In some embodiments, the user interface 1224 is coupled to or positioned on a housing or body of the user device 1110. The user interface 1124 is configured to receive an input from a user or operator. For example, as shown in FIG. 14, the user interface 1124 may include a display 1302, a keyboard 1304 including a plurality of inputs, and a number pad 1306 including number inputs. Each of the keyboard 1304 and the number pad 1306 include one or more buttons or are screens that display one or more display buttons configured to receive an input from the user. In some embodiments, the keyboard 1304 includes an alphabet or frequently used inputs, and the number pad 1306 includes numbers configured to receive a keycode including one or more letters, numbers, or other symbols provided for selection by the user engaging or pressing corresponding keys on the keyboard. The keyboard may be a physical keyboard with buttons having corresponding switches, a touch screen that displays a keypad, or another type of keypad providing options for different selections by a user.

In some embodiments, the keycode may be a series of one or more letters, numbers, or other symbols associated with at least one of a user or a machine. The keycode, once received, may be stored in the memory 1116. The memory 1116 also stores instructions, that in response to receiving the keycode, causes the processor 1114 to carry out an operation, such as unlocking data or providing access to data or operation associated with one or more work machines. In some embodiments, the user device 1110 is configured to in response to receiving the keycode as an input from the user, validate or verify the keycode. For example, the memory 1116 may store information indicative of allowable keycodes. In other embodiments, the user device 1110 may validate or verify the received keycode based on a database (e.g., a cloud database, the propulsion system 725, etc.) In response to determining that the keycode is allowable or verifiable, the user device 1110 may allow the user access to view data, control or operate one or more work machines (e.g., vehicle 10, PPE 100, etc.). In response to determining the keycode or keycodes received is not verifiable or not allowable (e.g., the keycode is incorrect, etc.), the controller 1112 is configured to lock, deny access to, or disengage the user device 1110 (e.g., prevent unwanted access to the user device 1110, etc.). The keycode may be associated with preset or predefined permissions. For example, the keycode may allow a user to access various data or information associated with a work machine. In other embodiments, the keycode is configured to provide access to operate the work machine (e.g., unlocks the machine for operation, etc.).

In some embodiments, a plurality of keycodes may be associated with a user or a machine. For example, a user may input a plurality of keycodes in order to access various information associated with the work machines or jobsite. In this embodiment, some information may be protected by one or more privacy walls that require a different keycode to unlock or surpass to access the information.

In some embodiments, the user interface 1124 also includes position control inputs 1308, display controls 1310, and a speaker/microphone 1312. Each of the position control inputs 1308, the 13 vehicle 10, and the speaker/microphone 1312 are configured to facilitate receiving and providing commands or inputs to the user device 1110 for controlling at least one of the user device 1110 or one or more work machines (e.g., the vehicle 10, the PPE 100, etc.)

In response to receiving the keycode via the user interface 1124, the controller 1112 is configured to control at least a portion of the user device 1110. For example, in response to receiving the keycode, the controller 1112 may unlock or provide access to various commands (e.g., that when selected are provided to at least one of the vehicle 10, the PPE 100, the remote device 205, the other PPE 215, or the tool 220).

When at least one of the display 1302 (e.g., when the display 1302 is a touch display), the keyboard 1304, or the number pad 1306 is engaged by the user, the user device 1110 may be configured to sync or communicably couple the user device 1110 to one or more of the work machines (e.g., to the vehicle 10, to the PPE 100, etc.). Similarly, when at least one of the display 1302 (e.g., when the display 1302 is a touch display), the keyboard 1304, or the number pad 1306 is engaged by the user, the user device 1110 may disconnect or disengage one or more of the work machines. In this embodiment, in response to receiving an input indicative of disconnecting he user device 1110 from a work machine, the user device 1110 may be configured to “lock” such that to access the vehicle 10 again, the user must reenter one or more keycodes.

In other embodiments, the user device 1110 may disengage or disconnect from one of the work machines or vehicles 10 based on a distance that the user device 1110 is positioned from the vehicle 10. For example, if the user device 1110 is moved to be greater than a threshold distance (e.g., 10 feet, 30 feet, 50 feet, etc.) from the vehicle 10, the user device 1110 is configured to automatically disconnect or disengage from the vehicle 10.

In some embodiments the user interface 1124 may include one or more lights. The one or more lights may be positioned at various points on the user device 1110 depending on the purpose of the lights. For example, a light of the one or more lights may be positioned under an end or face of the user device 1110 to indicate an operational state of the user device 1110 or one of the vehicle 10, the PPE 100, the tool 220, or any other device communicably coupled to the user device 1110.

Referring to FIG. 13, the user device 1110 may be coupled to other external devices or machines via the communication interface 1118. The user device 1110 may be coupled to the vehicle 10. As described herein, the vehicle 10 may be any type of vehicle or work machine (e.g., boom lift, scissor lift, refuse truck, mixer truck, fire fighting truck, etc.) on a jobsite with the user device 1110. In some embodiments, the vehicle 10 can communicate information obtained from one or more sensors on the vehicle 10 to the user device 1110 and the user device 1110 can communicate information (e.g., obtained from for example the sensors 1122) to the vehicle 10. In some embodiments, one or more actions can be performed (e.g., by the controller 102) based on the information from the vehicle 10 and/or the user device 1110. For example, the movement or operation of the vehicle 10 may be controlled in response to a command or signal from the user device 1110 based on data or information received by at least one of the PPE 100 or tool 220. In such examples, the controller 1112 may provide, via the communication interface 1118, a command or instruction to the vehicle 10, and a controller onboard the vehicle may process the command or instruction to carry out the action within the command or instruction. The actions can include movement of the vehicle 10 or a portion thereof (e.g., an actuator, a lift device, an end effector, a climate control system, a lighting system, an ignition system, a security system, a steering system, etc.).

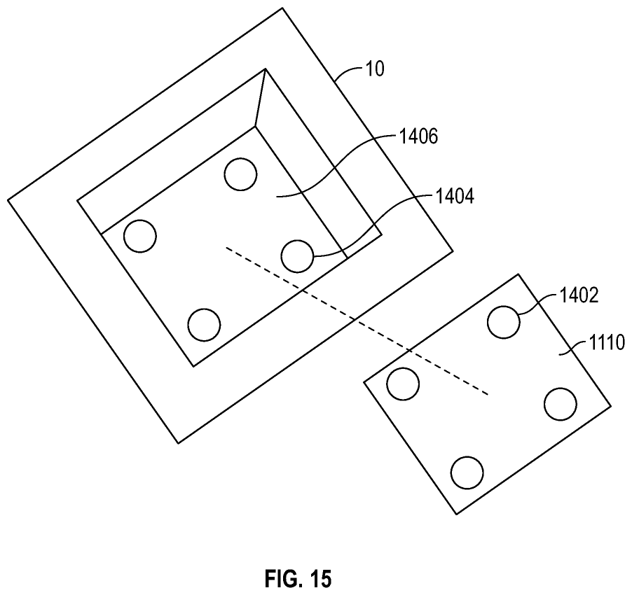

In some embodiments, the user device 1110 may be physically positioned on or coupled to the machine or device. For example, the user device 1110 may be configured to be coupled to the vehicle 10 in a similar orientation to the user interface 20 as shown in FIG. 11. As shown in at least FIG. 15, the user device 1110 may include brackets or a mount 1402 configured to receive or be coupled to a machine mount 1404. For example, the user device 1110 may be removably coupled to at least one of a vehicle 10 or a tool 220. The user device 1110 may be configured to be coupled to the vehicle 10 at a first time period and then removed from the vehicle 10 and coupled to the tool 220 at a second time period. When the user device 1110 is positioned on or coupled to the vehicle 10, the user device 1110 is configured to provide signals to the vehicle 10 and/or control one or more operations of the vehicle 10. As shown in FIG. 15, the mount 1402 are positioned on a side of the user device 1110 (e.g., a side opposite the user interface 1124, a back side, etc.) In some embodiments, the machine mount 1404 are positioned on a recessed surface 1406 of the work machine or vehicle 10. For example, the recessed surface 1406 may receive the user device 1110 such that the user interface 1124 of the user device 1110 is substantially flush with a surface of the vehicle 10. In some embodiments, the mount 1402 and the machine mount 1404 are magnets. In other embodiments, the machine mount 1404 is a bracket, and the mount 1402 may be a complimentary mounting bracket configured to be received by the machine mount 1404.

When the user device 1110 is coupled to the tool 220, the user device 1110 is configured to provide signals to the tool 220 and/or control one or more operation of the tool 220. In some embodiments, the user device 1110 may be coupled to a machine and can also remotely provide signals to a remote machine. For example, when the user device 1110 is coupled to one of the vehicle 10, the user device 1110 may remotely control or provide signals to another vehicle 10 or a tool 220. As such, the user device 1110 is configured to universally control each of the machines within a jobsite. For example, an operator may couple the user device 1110 to a first vehicle 10 provide signals to or control operation of the first vehicle 10 via the user device 1110, and then remove the user device 1110 from the first vehicle 10 and couple the user device 1110 to a second vehicle 10 and provide signals to or control the second vehicle 10 via the user device 1110. For example, an operator may couple the user device 1110 to the vehicle 10 to obtain operational data from the vehicle 10. In some embodiments, the operator may couple the user device 1110 to control operation, such as movement, speed, direction, etc. of the vehicle 10. In yet another embodiment, the user device 1110 is configured to provide signals to one of the PPE 100 to control operation of the PPE 100 as previously described.

In other embodiments, the user device 1110 is configured to be communicably coupled to, or remotely coupled to, one or more machines in a jobsite. For example, the user device 1110 may be wirelessly coupled to one or more machines (e.g., one or more vehicle 10, one or more PPE 100, one or more tool 220, etc.) via Bluetooth. In some embodiments, the user device 1110 is communicably coupled to each of the machines within a jobsite. In other embodiments, the user device 1110 is communicably coupled to each of the machines in the jobsite in a “waiting mode” and, based on for example a selection (e.g., a user input, a user provided keycode, etc.) or the user device 1110 being within a distance from the machine (e.g., as sensed or determined by the controller 1112), the user device 1110 is configured to wireless connect to or communicate with one of the machines (e.g., in a “connected mode”). As such, the user device 1110 may be positioned in various areas of the jobsite and engaged in the “connected mode” with a plurality of machines. For example, the user device 1110 may be configured to be positioned on a user (e.g., carried by a user, etc.) and engaged in the “connected mode” with various machines based on the actions of the user. In an example, the user may select a first vehicle 10 to operate via the user device 1110 and then select a second vehicle 10 positioned away from the first vehicle 10 to operate via the user device 1110. When the user device 1110 is engaged in the “connected mode” with the first vehicle 10, the user device 1110 may be passively in the “waiting mode” with in the second vehicle 10. As such that user device 1110 may be a universal user device 1110 that is configured to be mobilized with a user and may provide and receive signals or commands from each of the machines within a jobsite.

In yet another embodiments, the user device 1110 is coupled to another device within the vehicle system 1100. For example, the user device 1110 may be communicably coupled to a mobile device (e.g., the remote device 205, a phone, a tablet, etc.). In some embodiments, the mobile device includes an application, that when selected, is communicably coupled to the user device 1110. For example, the mobile device may receive a keycode, and in response to determining the keycode is correct or allowable (e.g., verifiable, etc.), the mobile device may provide a signal to the user device 1110 to unlock or allow the user to access the user device 1110 for controlling or accessing data associated with various work machines on the jobsite. For example, the user device 1110 may require dual authentication prior to granting or allowing a user access to the user device 1110. In other embodiments, the mobile device is configured to configured to receive an input causing the user device 1110 to be partied or synced to one of the work machines the jobsite.

### Work Machine

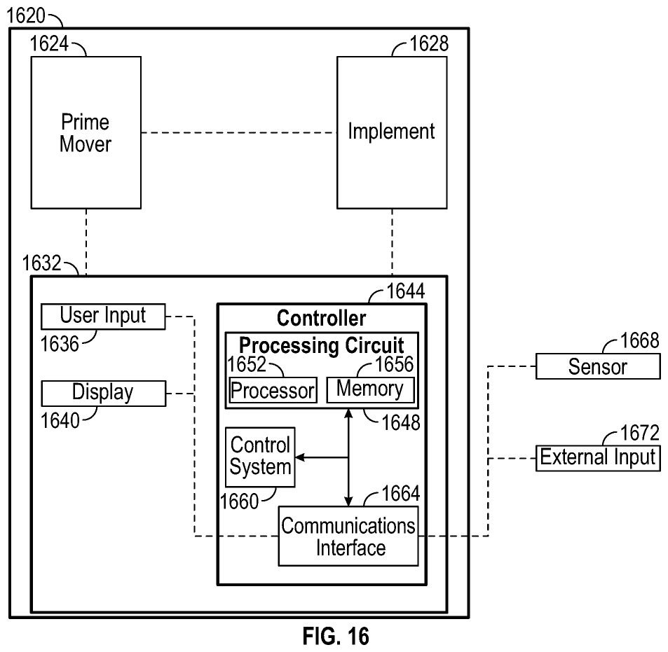

As shown in FIG. 16, a work machine 1620 (e.g., a telehandler, a boom lift, a scissor lift, etc.) includes a prime mover 1624 (e.g., a spark ignition engine, a compression ignition engine, an electric motor, a generator set, a hybrid system, etc.) structured to supply power to the work machine 1620, and an implement 1628 driven by the prime mover 1624. In some embodiments, the implement 1628 is a lift boom, a scissor lift, a telehandler arm, etc. In other embodiments, the implement 1628 is another component of the work machine 1620 (e.g., a cab, a platform, a container, etc.).

An interface 1632 (e.g., a user interface, a control interface, etc.) is arranged in communication with the prime mover 1624 and/or the implement 1628, for example to control one or more operations of the work machine 1620. The interface 1632 is shown to include a user input 1636 that allows a user or operator to interact with the interface 1632, a display 1640 for communicating to the operator (e.g., a display screen, a lamp or light, an audio device, a dial, or another display or output device), and a controller 1644.

As the components of FIG. 16 are shown to be embodied in the work machine 1620, the controller 1644 may be structured as one or more electronic control units (ECU). The controller 1644 may be separate from or included with at least one of an implement control unit, an exhaust after-treatment control unit, a powertrain control module, an engine control module, etc. In an exemplary embodiment, and as will be described herein, the controller 1644 may control operation of one or more components of the work machine 1620 (e.g., the prime mover 1624, the implement 1628, the interface 1632, etc.).

As shown, the controller 1644 includes a processing circuit 1648 having one or more processors, shown as processor 1652, and one or more memory devices, shown as a memory 1656. The memory 1656 may contain one or more instructions that, when executed by the processor 1652, cause the processor 1652 to perform various functions and/or operations, described herein.

In some embodiments, the controller 1644 also includes a control system 1660 and a communications interface 1664. Generally, the controller 1644 is structured to receive inputs and/or generate outputs. For example, the controller 1644 may receive inputs and/or generate outputs for or from one or more sensors, shown as a sensor 1668, and/or external inputs or 1672 (e.g. a load map, a machine-to-machine communication, a fleet management system, a user interface, a network, etc.), for example via the communications interface 1664. In this sense, the communications interface 1664 (e.g., a communication circuit, a network interface, etc.) may facilitate communication between (e.g., to and from) the work machine 1620 other components or systems described herein. The communication interface 1664 may facilitate wired communication (e.g., through CAN, Ethernet, communication of power, etc.). Additionally or alternatively, the communication interface 1664 may facilitate wireless communication (e.g., e.g., Bluetooth, NFC, Zigbee, radio, inductive transmission of energy, WiFi, cellular, satellite, etc.).

The control system 1660 may be configured to generate a range of inputs, outputs, and user interfaces. The inputs, outputs, and user interfaces may be related to user or operator information, including, for example, vital information (e.g., heartrate, respiratory rate, body temperature, etc.), body characteristics (e.g., posture, movement, positioning, twitching, rapid movements, etc.), movement trends or tendencies (e.g., slouching, slumping, standing, sitting, etc.), and/or other suitable information relating to a user or operator. In some embodiments the inputs, outputs, and/or user interfaces may be related to sensor data (e.g., user or operator information, equipment telematics, equipment component information, etc.), environmental conditions (e.g., weather, temperature, etc.), conditions surrounding the work machine 1620 (e.g., presence or absence of equipment or persons, movement of equipment or persons, etc.), equipment telematics (e.g., movement direction, speed, etc.), equipment location information (e.g., jobsite or storage information, transportation or travel information, etc.), equipment consumables data (e.g., fuel level, battery level, etc.), task instructions, performance data, reprograming and/or reconfiguration data, and/or other suitable data described herein (e.g., prioritization data, predictive task or maintenance data, etc.). In some embodiments, the inputs, outputs, and/or user interface may also relate to similar information relating to another work machine or piece of equipment (e.g., a connected work machine or piece of equipment, etc.).

As described herein, the sensor 1668 can include one or more physical and/or virtual sensors, for example for determining one or more properties or characteristics associated with the work machine 1620 (e.g., a user or operator of the work machine 1620, etc.), and/or a surrounding component, device, or space. In an exemplary embodiment, the sensor 1668 is a wave sensor (e.g., a millimeter wave sensor, etc.). In other embodiments, the sensor 1668 is another suitable sensor (e.g., environmental sensor, biometric sensor, position sensors, mapping sensor, imaging sensor, orientation sensor, acceleration sensor, etc.).

In some embodiments, the controller 1644 is or includes the control system 1660, such that the controller 1644 is configured to perform the same or similar operations as the control system 1660 described herein. For example, the processing circuit 1648 may be structured or configured to execute or implement the instructions, commands, and/or control processes described herein with respect to control system 1660. The depicted configuration represents the control system 1660 as machine or computer-readable media. However, this illustration is not meant to be limiting as the present disclosure contemplates other embodiments where the control system 1660, or at least one circuit of the control system 1660, is configured as a hardware unit. All such combinations and variations are intended to fall within the scope of the present disclosure.

### Connectivity System

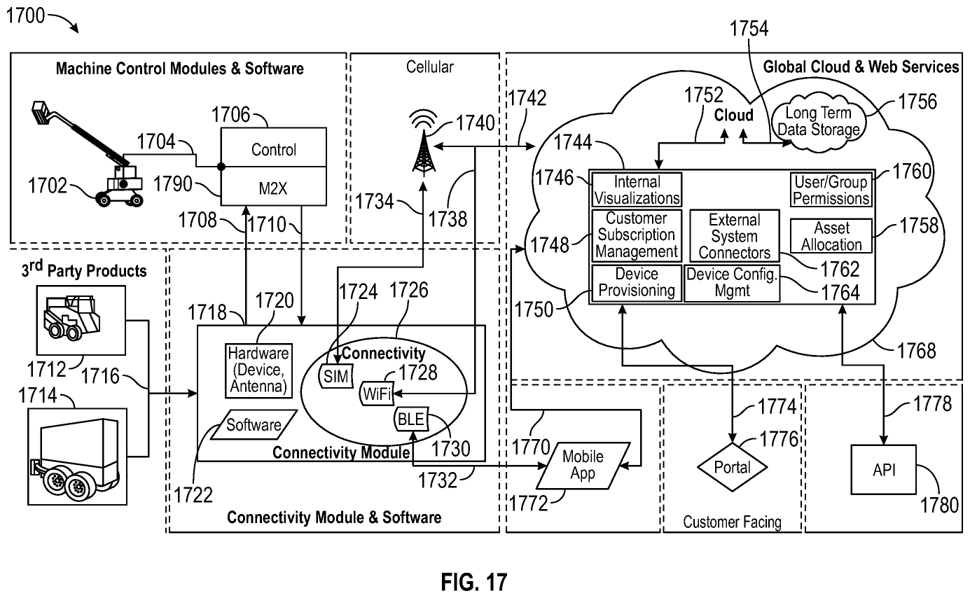

Referring generally to FIG. 17, a system is shown, according to an example embodiment. In an exemplary embodiment the system of FIG. 17 may be a connectivity system, a fleet connectivity system, a fleet system, a fleet management system, a work site system, a work site management system, a system for automatic generation of work site equipment groupings, a system for equipment identification, a system for equipment and/or fleet identification, and/or any other suitable system. It should be understood that while the term “systems” is used herein with different reference numerals, it should be understood that like reference numerals may refer to the same or similar elements.

As shown in FIG. 17, a system 1700 includes or is supported by a network of nodes. The network of nodes may include one or more work machines 1702, each with a controller or control module, shown as control module 1706, one or more connectivity modules 1718, and one or more network devices hosting, for example, user devices 1772 including user interfaces, network portals 1776, application interfaces/application programming interfaces 1780, data storage systems 1756, cloud and web services, and product development tool and application hubs 1744.

The work machine 1702 is communicably connected to a control module 1706. The connection 1704 between the work machine 1702 and the control module 1706 may be wired or wireless thus providing the flexibility to integrate the control module with the work machine 1702 or to temporarily attach the control module 1706 to the work machine 1702. The control module 1706 may be configured or may be reconfigurable in both hardware and software to interface with a variety of work machines 1702, 1712, 1714 via the connectivity module 1718. The control module 1706 may comprise an integral power source or may draw power from the work machine 1702 or another external source of power. Control modules 1706 may be installed on or connected, e.g., via a connection 1716, to products (e.g. work machines 1712, 1714) not configured by the original product manufacturer with a control module 1706.

The work machine 1702 communicably connects to the system 1700 via a machine-to-X (M2X) module 1790. The M2X module 1790 is communicably connected to the control module 1706. The M2X module 1790 establishes one or more communications channels 1708, 1710 with a connectivity module 1718. The connectivity module 1718 provides a plurality of links between one or more work machines 1702, 1712, 1714 and the system 1700. Applications providing functions for the system 1700 may be run by the M2X modules on one or more work machines 1702. One or more user devices 1772 may be configured to communicate (e.g., to exchange commands, codes (e.g. a customer key) and data) with the connectivity modules of one or more machines via a network connection, for example via a local wireless connectivity system or via a cellular networks (e.g., via cell towers 1740) to form a network of interconnections among machines, devices, or nodes. Connections between machines and user devices in the system 1700 may be provided by a wireless mesh network, for example.

The connectivity module 1718 comprises hardware 1720, further comprising antennas, switching circuits, filters, amplifiers, mixers, and other signal processing devices for a plurality of wavelengths, frequencies, etc., software hosted on a non-volatile memory components 1722, and a communications manager 1726. The communications manager 1726 may comprise processing circuits with communications front ends 1724, 1728, and 1730 for one or more signal formats and waveforms including, for example, Bluetooth, Bluetooth low energy, Wi-Fi, cellular, optical, and satellite communications. The connectivity module 1718 may function as a gateway device connecting work machine 1702 to other work machines 1712, 1714, remote computing systems, such as product development tool and application hubs 1744, user devices 1772, network portals 1776, and application programming interfaces 1780, beacons, scheduling or other fleet management and coordination systems.

The system 1700 allows for the coordination of multiple machines 1702, 1712, 1714 within the same location (e.g., a work site, storage facility, manufacturing facility, etc.), or a fleet wide control. For example, a work machine 1702 may remotely report the results of a self-monitoring or a self-inspection to a user via a user device 1772 including a user interface.

The system 1700 provides connectivity between work machines 1702, 1712, 1714 and remotely hosted user devices 1772 including user interfaces, network portals 1776, application interfaces/application programming interfaces 1780, data storage systems 1756, cloud and web services 1768, and product development tool and application hubs 1744 that function as an Internet of Things (IoT) system for operation, control, and support of work machines 1702, 1712, 1714 and users of work machines. Connections 1732, 1734, 1738, 1742, 1752, 1754, 1770, 1774, and 1778 between nodes connected to the system 1700 may comprise, for example, cellular networks (e.g., via cell towers 1740), or other existing or new means of digital connectivity.

Product development tool and application hubs 1744 may comprise tools and applications for internal visualizations 1746, customer subscription management 1748, device provisioning 1750, external systems connectors 1762, device configuration management 1764, user/group permissions 1760, asset allocation 1758, fleet management, compliance, etc.

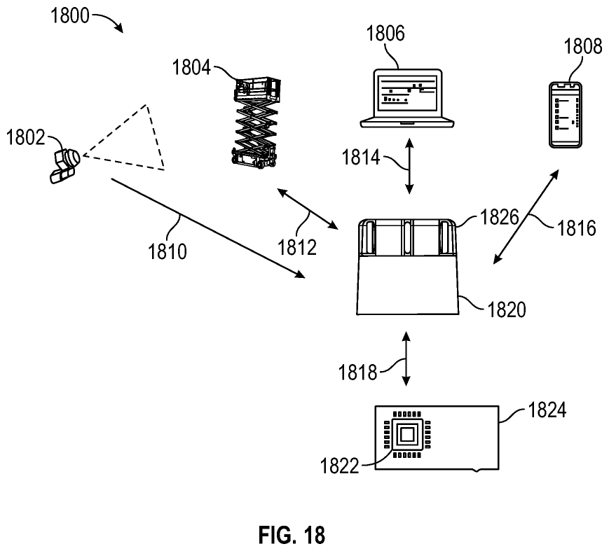

FIG. 18 shows a system 1800 according to an exemplary embodiment. The system 1800 may be the same as or similar to the system 1700 of FIG. 17. As shown in FIG. 18, the connectivity module 1820 functions as a communications interface between a control system 1822 of the work machine 1824 (e.g., a control system, etc.) and other elements connected to the system 1800. The connectivity module 1820 may be part of the work machine 1824, may be physically coupled to the work machine 1824, and/or may be configured to communicate with the work machine 1824 (e.g., via an interface, etc.).

In some embodiments, the connectivity module 1820 is a self-contained unit. For example, the connectivity module 1820 may be installed on or connected to machines not configured by the original product manufacturer with a connectivity module 1820, and may be configured to communicate with the control module of the machine. In some embodiments, the connectivity module 1820 is integrated with other components of the work machine 1824 (e.g., a control system, a controller, another component, etc.), as described elsewhere herein. The connectivity module 1820 may exchange data and/or commands 1818 with the control system 1822 of the work machine 1824 (e.g., the controller 1644 of the FIG. 16), sensor data 1810 with one or more sensors 1802, machine data 1812 with another machine 1804, commands and data 1814 with a portal or node 1806, and commands and data 1816 with a user device 1808 running an application for the system 1800. The connectivity module 1820 may exchange commands, codes (e.g. a customer key) and data between work machines 1804, 1824, user devices 1808, and/or nodes 1806 to form a network of interconnections among machines, devices, or nodes.

As shown, the connectivity module 1820 may include an equipment indicator, shown as indicator 1826. The indicator 1826 may provide an indication or signal to a user or observer, for example an indication or signal regarding a status of a user or operator, or of the machine. The indicator 1826 may be configured, for example, as a node of the system 1800. In an example embodiment, the indicator 1826 is integrated with the connectivity module 1820; however, in other embodiments the indicator 1826 is in communication with the connectivity module 1820, and/or integrated with another component of the system 1800 (e.g., the work machine 1824, etc.). For example, the indicator 1826 may be a machine component (e.g., a headlight, horn, taillight, etc.) and/or a separate device of the work machine 1824 (e.g. an external machine light, an internal machine light, a horn, etc.). In other embodiments, the indicator 1826 includes and/or is integrated with a beacon. The indicator 1826 may be a light or lighting device (e.g. an incandescent light, a light emitting diode, a fixed beacon, a flashing beacon, a rotating beacon, a laser, a light array, etc.), a display device (e.g., display screen, application, mobile device, sign, etc.), a marker, another suitable indicator, etc. In some embodiments, the indicator 1826 incorporates an audible indication of a machine status (e.g., an alarm, a message, etc.).

In an exemplary embodiment, the indicator 1826 is configured to generate a variety of indications and/or signals, for example visual, audible, tactile, etc. signals. In some embodiments, the indicators includes visual signals that comprise one or more colors (e.g., white, red, blue, green, orange, etc.), patterns (e.g., solid, flashing, strobed, etc.), and/or any other suitable combination of colors and/or patterns. For example, the indicator 1826 may include a flashing visual indicator, a solid or consistent state indicator, a combination of flashing visual indicators and/or consistent state indicators, and/or any combination thereof. Each indication/signal provided by the indicator 1826 may represent a different status of a user or operator, and/or machine status (or the status of a component thereof). The visual patterns generated by the indicator 1826 can be varied in any optical characteristic (e.g. color, wavelength, intensity, pulse duration, direction, etc.), which may be controlled or defined by a user or operator (e.g., via a request, instruction, input, etc., for example provided or supplied through an application or interface, etc.). In other embodiments, the indicator 1826 is configured to generate an audible indicator (e.g., a noise, alarm, warning, message, etc.), a tactile signal (e.g., vibration, etc.), and/or any other suitable indicator or signal (e.g., a message to a user device, an icon on an application, etc.).

According to an exemplary embodiment, the system 1800 facilitates the coordination of a plurality of machines within the same work site, fleet, and/or location, (e.g., the work machine 1824, another machine 1804, etc.). For example, the work machine 1824 and another machine 1804 may include connectivity modules 1820, and may be communicably connected to a hub (e.g., a connectivity hub, etc.). The connectivity hub may be configured to communicably connect one or more connectivity module equipped machines (e.g., to increase communication, efficiencies, etc.), for example to perform one or more operations or functions described herein. In some instances, the connectivity hub may be configured to receive information and/or data (e.g., user or operator data, machine data, etc.) from a plurality equipped machines, for example to analyze and/or report the information or data (e.g., site-wide user or operator information, etc.). As will be described herein, the connectivity hub may further be configured to implement one or more actions based on the information or data (e.g., provide instructions, notifications, or warnings to users or operators based on the site-wide user data, etc.). Yet further, the connectivity hub may be configured to coordinate operations of equipped machines based on the information or data (e.g., provide instruction to replace a work machine or piece of equipment, provide instruction to deploy a piece of equipment to assist a work machine, provide an instruction relating to zones of operation and/or non-operation, etc.). All such operations are contemplated herein.

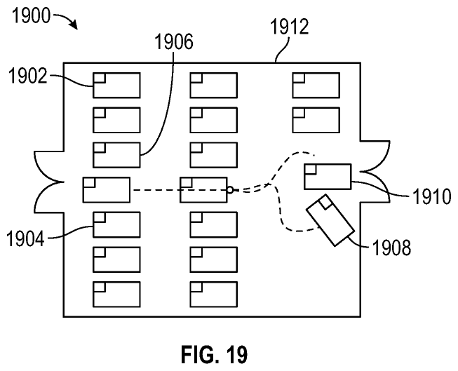

For example, and as shown in FIG. 19, a system 1900 may be deployed at a work site. As discussed herein, the system 1900 may be the same as or similar to the systems of FIGS. 17-3. According to an exemplary embodiment, the system 1900 may be deployed at a work site 1912 to control a fleet of work machines 1902, 1904, 1908, 1910 (e.g., via the connectivity modules and/or the connectivity hub, as discussed herein) to collaboratively perform tasks requiring more than one work machine 1908, 1910. For example, a user may wish to move the work machine 1910 from its stored position on the left of the work site 1912 out the door on the right of the work site. The connectivity hub may communicate with both the work machine 1908 and the work machine 1910, causing the work machine 1908 to move out of the way of the work machine 1910, so that the work machine 1910 can move past the work machine 1908 and out the doorway.

In some embodiments, one or more work machines may communicate with the connectivity hub (e.g., via connected connectivity modules, etc.), for example providing information relating to a status or condition of a user or operator. For example, and as will be described herein, the work machine 1906 may communicate with the connectivity hub (e.g., via the connectivity module, etc.), indicating that an operator of the work machine 1906 is incapable of moving the work machine 1906 (e.g., due to incapacitation, an elevated stress level, etc.). The connectivity hub may communicate an instruction to the work machine 1906 to prevent or limit movement of the work machine 1906 (e.g., a power down or off instruction, an instruction to stop the motor or prime mover, etc.), for example to prevent the operator from moving the work machine 1906. Further, the connectivity hub may communicate an instruction the work machines 1908, 1910, causing the work machines 1908 and 1910 to move out of the path to the work machine 1906 (e.g., to provide assistance to the work machine 1906, etc.). In this regard, and as will be described herein, the systems and devices described herein may be configured to collect, communicate, analyze, and/or provide information and instructions to collaboratively perform one or more operations.

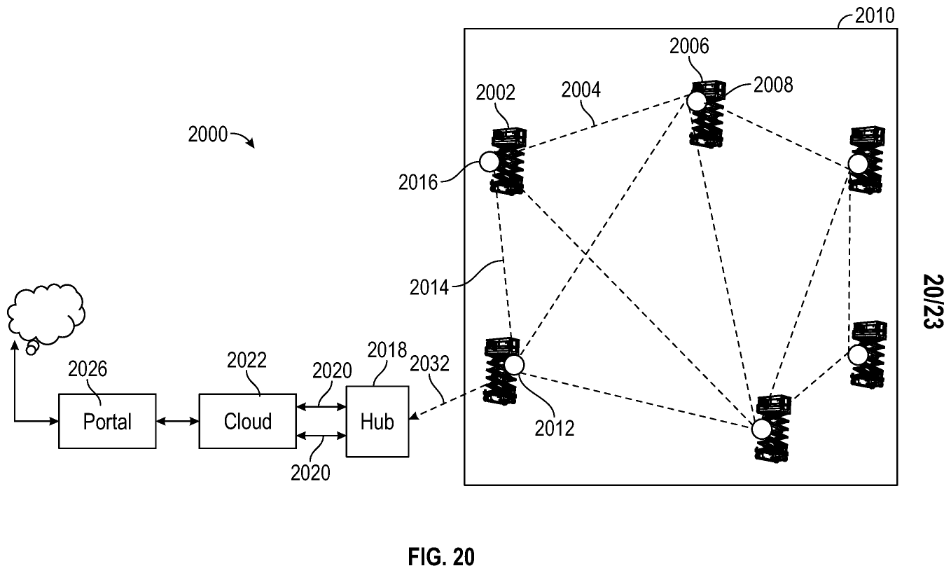

Referring now to FIG. 20, a system 2000 is shown to include one or more connectivity modules and/or a connectivity hub. As discussed herein, the system 2000 may be the same as or similar to the systems of FIGS. 17-19. In an example embodiment, the system 2000 includes a connectivity hub 2018, which can include one or more connectivity modules. As described herein, the connectivity hub 2018 is configured to communicatively connect with one or more connectivity module equipped machines 2002, 2006 (e.g., via connectivity modules, etc.) in proximity to the connectivity hub 2018. In some embodiments, the connectivity hub 2018 is configured to broadcast a work site identification signal. In some embodiments, the connectivity hub 2018 is configured to connect work site machines 2002, 2006 connected to the local fleet network to an external internet feed 2020. In some configurations, the connectivity hub 2018 is configured as a gateway to one or more communications systems or network systems to enable exchanges of data between nodes 2008, 2012, 2016 on the work site 2010 local fleet connectivity mesh network 2004, 2014, 2032 and nodes 2026 external to the work site. In some embodiments, connectivity hub 2018 has a connectively module to (a) provides the functionalities described here in place of or in addition to a machine that has a connectivity module, (b) broadcasts a site identifier, or (c) connects to an external internet to flow through data to and from the jobsite that is provided across the mesh.

### User or Operator Status Monitoring System

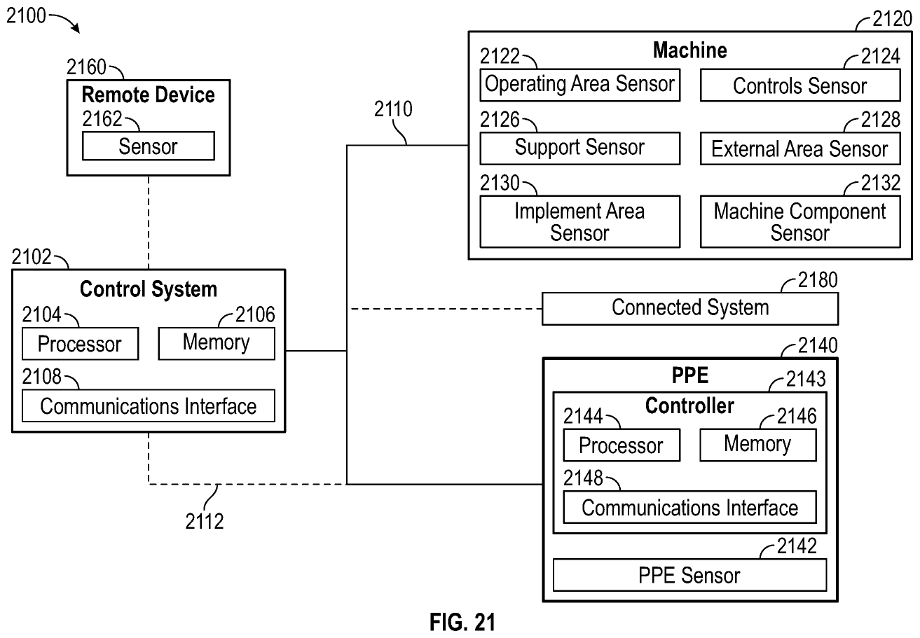

Referring now to FIG. 21, a system 2100 is shown, according to an exemplary embodiment. The system 2100 may be a user status monitoring system, an operator status monitoring system, a monitoring system, and/or a connected monitoring system, for example to allow for monitoring of one or more characteristics (e.g., status, features, actions, etc.) of a user or operator of one or more pieces of work equipment (e.g., a work machine, a vehicle, etc.). According to an exemplary embodiment, the system 2100 may be integrated with or a part of the work machine 1620 of FIG. 16 and/or the systems of FIG. 17-20.

According to an exemplary embodiment, and as will be described herein, the components of the system 2100 are configured to obtain information (e.g., via one or more sensors, etc.) associated with persons, machines, and/or spaces at a location (e.g., a job site, a warehouse, a storage facility, a manufacturing facility, etc.). Further, the components of the system 2100 are configured to assess the information, and in some instances determine that one or more persons, machines, and/or spaces are exhibiting potentially hazardous characteristics. Based on that determination, the components of the system 2100 may be configured to implement one or more actions (e.g., provide an operation or control instruction, an alert or notification, etc.), for example to limit or prevent potential harm to the persons or space, and/or to limit or prevent potentially hazardous operations or conditions at the location.

As shown, the system 2100 includes a controller, a control device, or a control system, shown as control system 2102. As will be described herein, the control system 2102 is configured to receive (e.g., obtain, retrieve, pull, request, etc.) information and/or data associated with one or more characteristics of a person (e.g., an operator, a user, etc.), and/or one or more pieces of equipment or spaces (e.g., a work machine, a space around a work machine, a job site, etc.). The control system 2102 may further be configured to analyze (e.g., process, assess, etc.) the information and/or data, and/or provide one or more outputs (e.g., controls, control instructions, notifications, warnings, etc.) based on the analysis.

In some embodiments, the control system 2102 is part of and/or implemented with the work machine 1620 of FIG. 16. For example, the control system 2102 may be implemented as, or a part of, the controller 1644 of the work machine 1620. In this regard, in some embodiments the controller 1644 of the work machine 1620 is configured to perform and/or implement the operations of the control system 2102 described herein. For example, in some example scenarios where the work machine 1620 is not connected or in communication with (e.g., disconnected, isolated from, etc.) one or more connections or networks (e.g., not connected to a wireless or mesh network, not connected to a network or node, etc.), the controller 1644 of the work machine 1620 may be configured to perform and/or implement the operations of the control system 2102, described herein.

In some embodiments, the control system 2102 is part of and/or implemented with the system or systems of FIGS. 17-20. For example, the control system 2102 may be implemented as, or a part of, the connected systems or networks of FIGS. 17-20 (e.g., a connectivity module, the connectivity hub, etc.). In this regard, in some embodiments the connectivity module (e.g., the connectivity module 1718 of FIG. 17, etc.) and/or the connectivity hub (e.g., the connectivity hub 2018 of FIG. 20, etc.) is/are configured to perform and/or implement operations of the control system 2102 described herein. For example, in some example scenarios where one or more work machines and/or PPEs are connected (e.g., via one or more connections or networks, etc.), the connectivity module 1718 and/or the connectivity hub 2018 may be configured to perform and/or implement operations of the control system 2102, as described herein.

As shown, the control system 2102 includes one or more processors, shown as processor 2104, one or more memory devices, shown as memory 2106, and a communications interface, shown as communications interface 2108. Similar to other components described herein, the memory 2106 contains instructions that, when executed by the processor 2104, cause the processor 2104 to perform various functions and/or operations, as described herein. Further, and also similar to other components described herein, the communications interface 2108 facilitates communication between (e.g., to and from) other components of the system 2100 (e.g., one or more vehicles, PPEs, remote devices, connected devices, etc.). It should be understood that it is contemplated that in other embodiments, the control system 2102 may be otherwise arranged, configured, and/or implemented (e.g., with additional and/or different components of the systems of FIGS. 16-20.

As shown in FIG. 21, the control system 2102 is communicably coupled with one or more systems, devices, and/or components (e.g., via the communications interface 2108). In this sense, the control system 2102 may communicate with one or more systems, devices, and/or components, for example via one or more connections (e.g., wired connection, wireless connection, etc.) to communicate information, data, commands, and/or instructions. The control system 2102 may be in communication via a single connection, or multiple connections. For example, the control system 2102 may be in communication with one or more components and/or systems of a machine or piece of equipment via a first connection, shown as connection 2110, and/or one or more remote or external devices or systems via a second connection, shown as connection 2112. The connections 2110, 2112 may be the same type of connection, or the connections 2110, 2112 may be different types of connections. All such types and/or combinations of connections and/or communication protocols described herein are contemplated.

For example, in an example scenario where the control system 2102 is a component of the work machine 1620 (e.g., the controller 1644 of FIG. 16, etc.), the control system 2102 may communicate with components of the work machine 1620 via one or more wired connections (e.g., via the connection 2110, through CAN, Ethernet, communication of power, etc.), whereas the control system 2102 may communicate with a PPE and/or a remote device via one or more wireless connections (e.g., via the connection 2112, via Bluetooth, Wi-Fi, radio transmission, inductive transmission of energy, a mesh network, etc.). Conversely, in another example scenarios where the control system 2102 is a component of a connected system or network (e.g., the connectivity hub 2018 of FIG. 20, etc.), the control system 2102 may communicate with components of the work machine 1620 via one or more wireless connections (e.g., the connection 2110, via Bluetooth, Wi-Fi, radio transmission, a mesh network, etc.) and the PPE or remote device via one or more wireless connections (e.g., the connection 2112, via Bluetooth, Wi-Fi, radio transmission, a mesh network, etc.), which may be the same or different from the connection with the work machine 1620 (e.g., the connection 2110). All such variations and combinations are contemplated herein.

As shown in FIG. 21, the system 2100 also includes a piece of work equipment or a work machine, shown as machine 2120. In some embodiments, the machine 2120 is the work machine 1620 of FIG. 16. In this sense, in some example scenarios the control system 2102 is implemented with, or as a part of, the machine 2120 (e.g., and/or connected via the connection 2110, etc.). In other embodiments, the machine 2120 is one of a plurality of machines, for example as one of a series of machines at a site (e.g., a job site, storage facility, manufacturing facility, etc.) or location. In this sense, while FIG. 21 illustrates a single machine 2120, it is contemplated that in other embodiments the system 2100 includes a plurality of machines 2120.

According to an exemplary embodiment, the machine 2120 includes one or more sensors. In an exemplary embodiment, the one or more sensors are configured to obtain (e.g., collect, determine, sense, etc.) information associated with the machine 2120. For example, the sensors may be configured to obtain information associated with an operator of the machine 2120 and/or one or more users of the machine 2120. Further, the sensors may be configured to obtain information associated with a characteristic or status of the machine 2120 itself, one or more spaces associated with the machine 2120 (e.g., an internal space, an exterior space, etc.), and/or an environment surrounding the machine 2120.

According to an exemplary embodiment, one or more sensors of the machine 2120 is/are a wave sensor (e.g., a millimeter wave sensor, etc.). The wave sensor may utilize short-wavelength waves (e.g., electromagnetic waves, etc.) to determine properties or characteristics associated with one or more components or spaces of the machine 2120. For example, and as will be discussed in detail herein, the sensor(s) may be used to determine vital information associated with an operator/user of the machine 2120 (e.g., heart rate, breathing characteristics, etc.), and/or posture or movement information associated with an operator/user of the machine (e.g., slouched or slumped posture, standing or sitting, rapid movement or twitching, labored or slow movements, a direction a person is facing or looking, etc.). Further, the sensor(s) may be used to determine positioning or movement information associated with a component of the machine 2120 (e.g., a rapid or delayed movement of a steering or control device, etc.) and/or a space in or around the machine 2120 (e.g., presence of too many users on a platform, movement of an object into a path of travel of the machine, etc.).

It should be understood that while the sensor or sensors described herein are described as being a wave sensor, it is contemplated that in other embodiments one or more of the sensors described herein are another suitable type of sensor (or a combination thereof). For example, the sensors may be mapping or imaging sensors (e.g., LIDAR sensors, light curtains, cameras, ultrasonic sensors, etc.), position sensors (e.g., GPS, proximity sensors, etc.), orientation or acceleration sensors (e.g., accelerometers, gyroscopic sensors, inertial measurement units, compasses, etc.), environmental sensors (e.g., sensors measuring temperature, humidity, pressure, air quality, light, sound, radiation, etc.), biometric sensors (e.g., sensors for measuring heart rate, blood oxygen levels, blood pressure, perspiration, etc.), and/or any other suitable sensor described elsewhere herein.

As shown, the machine 2120 includes an operating area or space sensor, shown as operating area sensor 2122, a controls or steering sensor, shown as controls sensor 2124, a support or seat sensor, shown as support sensor 2126, an external space or remote area sensor, shown as external area sensor 2128, an implement space or platform area sensor, shown as implement area sensor 2130, and a vehicle or machine component sensor, shown as machine component sensor 2132. In an exemplary embodiment, the sensors 2122-2132 are configured to obtain (e.g., collect, determine, sense, etc.) information associated with one or more conditions or characteristics of a person, component, and/or space, and communicate the information to components of the system 2100 (e.g., the control system 2102, etc.).

According to an exemplary embodiment, the operating area sensor 2122 is configured to obtain information associated with the conditions of an area or space where a user or operator may be located. For example, the operating area sensor 2122 may be coupled inside a cab (e.g., on a roof, sidewall, panel, dashboard, etc.), or at a platform or working area of the machine 2120, and may be configured to obtain information associated with the conditions of an operator and/or the components within the working area.

In some instances, the operating area sensor 2122 is configured to operate as a broad-area sensor or general area sensor (e.g., to monitor generally conditions within the cab of the machine 2120, etc.). For example, the operating area sensor 2122 may be configured to monitor movement and/or positioning of objects within the operating area. In this sense, the operating area sensor 2122 may be configured to determine conditions within the operating area, such as the presence or absence of an operator, a number of persons in the operating area, a posture of an operator (e.g., standing, sitting upright, slouching, slumped, etc.), movement of the operator, etc. In some instances, the posture and/or movement of the operator may also be used to determine/detect other conditions within the operating area, such as whether the operator is operating controls of the machine 2120 (e.g., using a steering wheel, operating a joystick, engaging with a foot pedal, etc.), whether the operator is eating or drinking, whether the operator is using a mobile device, etc.

In some instances, the operating area sensor 2122 is configured to operate as a focused-area sensor or concentrated area sensor (e.g., to monitor specific areas or conditions within the cab, etc.). For example, the operating area sensor 2122 may be configured to monitor specific movements and/or positioning of objects within the operating area.

As an illustrative example, the operating area sensor 2122 may be focused on an area where a chest or abdominal region of an operator may be positioned. In this sense, the operating area sensor 2122 may be configured to determine one or more conditions associated with an operator, such as an operator's respiratory patterns (e.g., increased or rapid breathing, labored or slow breathing, etc.), an operator's heart rate, an operator's chest or upper body posture (e.g., upright, slouched or slumped, leaning or tilting, etc.), and/or other suitable operator characteristics.

As another illustrative example, the operating area sensor 2122 may be focused on an area where a head or face of an operator may be positioned. In this sense, the operating area sensor 2122 may be configured to determine conditions associated with an operator, such as whether the operator's eyes are opened or closed (or opening/closing, etc.), which direction the operator is facing or looking, whether the operator's head is moving (e.g., drooping, nodding, looking in various directions, etc.), whether the operator is talking or eating, and/or other suitable operator characteristics.

As yet another illustrative example, the operating area sensor 2122 may be focused on an area where a hand or the hands of an operator may be positioned (e.g., at their side, at the controls, etc.). In this sense, the operating area sensor 2122 may be configured to determine conditions associated with an operator, such as whether the operator's hands are twitching or shaking, whether the operator's hands are placed on the controls, and/or other suitable operator characteristics.

In some instances, the operating area sensor 2122 is also configured to operate as a focused-area sensor, for example to monitor conditions of one or more components within the operating area. As an illustrative example, the operating area sensor 2122 may be focused on an area where one or more controls of the machine 2120 are located (e.g., a dashboard, etc.). In this sense, the operating area sensor 2122 may be configured to determine conditions associated with operating the controls, such as a frequency and/or style of movement of a steering wheel or joystick (e.g., frequent movements, rapid movements, jerky or non-smooth movements, etc.), frequency and/or style of engagement with a foot pedal or drive control, and/or other suitable component characteristics.

In some embodiments, the operating area sensor 2122 is configured to transition between broad-area and focused-area sensing capabilities. For example the operating area sensor 2122 may be configured to broadly monitor conditions within an operating area to determine when an operator enters the working area (e.g., the cab or platform, etc.), and once it is determined the operator is in the working area, the operating area sensor 2122 may focus or narrow the detection area (e.g., zoom, etc.) to a portion of the operating area and/or the operator (e.g., the operator's head, face, chest, hands, etc.).

In other embodiments, the operating area sensor 2122 is also configured to transition between or amongst different areas of focus. For example, and as a non-limiting example, the operating area sensor 2122 may be configured to transition between monitored areas at an operator's head to their chest, from an operator's chest to their hands, from their hands to the controls area, etc. In some instances, the operating area sensor 2122 is movable as a result of a movable mount or coupling, whereas in other embodiments the operating area sensor 2122 is movable between monitored areas as a result of narrowing/broadening of the focus area (e.g., zoom out/in, etc.) and changing a focal point. According to an exemplary embodiment, the operating area sensor 2122 is configured to move between sensing configurations (e.g., broad-area and focused-area, etc.) and/or areas of focus (e.g., different areas associated with different operator anatomy, components of the machine 2120, etc.) automatically, for example as a result of looped controls and/or control configurations (e.g., control rules, etc.).

According to an exemplary embodiment, the controls sensor 2124 is configured to obtain information associated with the conditions of one or more controls components or devices of the machine 2120. For example, the controls sensor 2124 may be coupled inside a cab (e.g., on a roof, sidewall, panel, dashboard, etc.), or at a platform or working area of the machine 2120, and may be configured to determine conditions associated with one or more controls operations. In this regard, the controls sensor 2124 may be configured to determine conditions, such as a frequency and/or style of movement of a steering wheel or joystick (e.g., frequent movements, rapid movements, jerky or non-smooth movements, etc.), a frequency and/or style of engagement with a foot pedal or drive control, a frequency and/or style of engagement with an implement or platform control (e.g., raising/lowering the platform, moving the platform, extending the platform, etc.), and/or other suitable control characteristics.

In some embodiments, the controls sensor 2124 is coupled with and/or integrated with one or more control components. For example, the controls sensor 2124 may be integrated with a steering wheel, a joystick, a foot pedal, and/or another suitable control component or mechanism (e.g., a button, interface, control panel, personal protective equipment, etc.). In some embodiments, the controls sensor 2124 is configured to determine conditions associated with the control component, as described herein. In other embodiments, the controls sensor 2124 is configured to determine one or more operator conditions and/or changes thereof. For example, the controls sensor 2124 may be configured determine operator conditions, such as grip force, hand placement, hand movement, application and/or removal of force (e.g., on a foot pedal, etc.), frequency of force application, and/or other suitable operator conditions. In other instances, the controls sensor 2124 may be configured to determine operator conditions. For example, the controls sensor 2124 may be a capacitive sensor, and/or may be configured to determine operator conditions, such as heart rate, blood pressure, breathing or respiration patterns, for example via contact between the user and the controls sensor 2124. All such variations and combinations are contemplated herein.

According to an exemplary embodiment, the support sensor 2126 is configured to obtain information associated with the conditions associated with one or more support structures of the machine 2120. For example, the support sensor 2126 may be coupled inside a cab (e.g., on a roof, sidewall, panel, dashboard, etc.), or at a platform or working area of the machine 2120, and may be configured to determine conditions associated with a structure configured to support an operator (e.g., a seat, a platform, a step, etc.). In this regard, the support sensor 2126 may be configured to determine operator conditions, such as a body position of an operator (e.g., seated, standing, bent over, etc.), and/or a posture of an operator (e.g., sitting upright, slouched, slumped, leaning, tilting, etc.). Further, the support sensor 2126 may be configured to determine changes in conditions, such as an operator changing position (e.g., standing up, sitting down, etc.) and/or sudden changes in positioning (e.g., an operator falls off the seat or falls onto the seat, for example as a result of an impact or sudden change in movement of the machine 2120, etc.).

According to an exemplary embodiment, the external area sensor 2128 is configured to obtain information associated with conditions of an area or space around or in an environment surrounding the machine 2120. For example, the external area sensor 2128 may be coupled to an exterior of the machine 2120 (e.g., a front of the cab, a side of the cab, an exterior surface of the body, etc.), and may be configured to obtain information associated with the conditions in the environment around the machine 2120.

Similar to the operating area sensor 2122, in some instances the external area sensor 2128 may be configured to operate as a broad-area sensor or general area sensor. For example, the external area sensor 2128 may be configured to determine conditions, such as the presence or absence of objects in an area surrounding the machine 2120, a number of objects in the surrounding area, movement and/or positioning of the objects in the surrounding area, and/or other suitable characteristics described herein.

Further, and also similar to the operating area sensor 2122, in some instances the external area sensor 2128 may be configured to operate as a focused-area sensor or concentrated area sensor. For example, the external area sensor 2128 may be configured to transition to focus on an area where an identified object is located, for example to further determine conditions, such as a type of the object, a path of the object, a speed of the object, movement characteristics of the object (e.g., direction, speed, acceleration or deceleration, etc.), and/or other suitable characteristics. In some embodiments, the area of focus of the external area sensor 2128 is determined based on a characteristic of the machine 2120 (e.g., a path, a direction of movement, a task, a speed, a position and/or configuration of an implement, such as a boom or arm, etc.). Similar to the operating area sensor 2122, and as described elsewhere herein, the external area sensor 2128 may be configured to transition between sensing configurations (e.g., broad-area and focused-area, etc.) and/or areas of focus, automatically.

According to an exemplary embodiment, the implement area sensor 2130 is configured to obtain information associated with the conditions of an implement of the machine 2120. As described herein, the implement may include a lift (e.g., a boom lift, scissor lift, etc.), an arm, and/or another component, for example a platform. Using the platform as a non-limiting example, the implement area sensor 2130 may be coupled with the platform (e.g., a rail, a door, a front, a control dashboard, etc.), and may be configured to obtain information associated with the conditions of the platform.

For example, the implement area sensor 2130 may be configured to determine conditions associated with the platform, such as a presence or absence of a user, a number of users, a posture of one or more users (e.g., standing, sitting, leaning or bending, etc.), a positioning of users relative to components of the platform (e.g., within the perimeter of the platform, whether a user is leaning over or on a railing, whether a user is standing on a step or stair, etc.). Further, the implant area sensor 2130 may be configured to determine conditions associated with a configuration of the platform, for example a height, a direction of movement, a speed and/or style of movement, a location of the platform relative to other objects (e.g., above a machine or piece of equipment, next to or adjacent a piece of equipment, etc.), and/or other suitable characteristics.

According to an exemplary embodiment, the machine component sensor 2132 is configured to obtain information associated with the conditions of one or more components of the machine 2120. As discussed herein, while the machine component sensor 2132 is shown as a single sensor, it is contemplated that there may be a plurality of machine components sensors 2132, which may be configured to obtain and/or communicate information associated with different components and/or systems of the machine 2120 (e.g., one or more of the systems, subsystems, and/or components of the machine 2120, etc.).

For example, the one or more machine component sensors 2132 may be configured to obtain conditions associated with an actuator (e.g., on/off status, operating efficiency, output, etc.), a lift assembly (e.g., a configuration, for example expanded/retracted, a height, etc.), a security system, a propulsion system, a climate control system (e.g., conditions or configurations of a fan, condenser, expander, heat exchanger, mister, etc.), and/or any other suitable system, subsystem, or component of the machine 2120 described elsewhere herein. The machine component sensor 2132 may be configured to obtain and/or communicate all such suitable information of the associated systems, as described herein.

It should be understood that while the sensors of the machine 2120 are described as separate sensors, it is contemplated that one or more of the sensors of the machine 2120 could be implemented as a single sensor. For example, a single sensor could be implemented to perform the operations of the operating area sensor 2122, the control sensor 2124, and/or the support sensor 2126.

Further, it should be understood that while the sensors of the machine 2120 are described herein as continuously obtaining and/or communicating associated information and data, it is contemplated that in some embodiments the sensors are configured to obtain and/or communicate information/data in certain combinations and/or sequences. For example, the operating area sensor 2122 may obtain information indicating that an operator has entered the working area (e.g., the cab, etc.), and the support sensor 2126 may obtain information (e.g., subsequently, substantially simultaneously, etc.) indicating that an operator is seated in the operating seat. In response (e.g., subsequently, substantially simultaneously, etc.), the controls sensor 2124 may begin obtaining information associated with whether the operator is activating and/or operating any controls, and/or the implement area sensor 2130 may be configured to begin obtaining information associated with the conditions of the platform (e.g., whether any users are present and/or a positioning or posture of any users that are present, etc.).

In this sense, it is contemplated that in some embodiments the sensors of the machine 2120 are configured to coordinate operations (e.g., act in sequence, in parallel, in combinations, etc.), for example to obtain and/or communicate information in a way that reduces the amount of data collected/communicated, as well as the computational resources needed to perform the operations described herein (e.g., reduced memory and/or processing requirements of the control system 2102, etc.), thereby increasing the speed at which information is assessed and/or instructions or commands are provided.

Referring still to FIG. 21, the system 2100 is shown to include a piece of personal equipment, shown as PPE 2140. As described herein, the PPE 2140 may be a wearable device, for example a hardhat, pair of safety glasses, vest, lanyard or other type of personal protective equipment (e.g., the PPE 100). According to an exemplary embodiment, and as will be described in greater detail herein, the PPE 2140 includes one or more sensors, shown as sensor 2142, which may be configured to obtain (e.g., determine, detect, collect, etc.) and/or communicate sensor data relating to a status of the PPE 2140, a surrounding environment, and/or a user of the PPE 2140.

In some embodiments, the PPE 2140 also includes a controller or control system, shown as controller 2143, which may control one or more operations of the PPE 2140. The controller 2143 is shown to include one or more processors or processing circuits, shown as processor 2144, and one or more memory devices, shown as memory 2146. Similar to other components described herein, the memory 2146 contains one or more instructions that, when executed by the processor 2144, cause the processor 2144 to perform the operations described herein. As shown, the PPE 2140 (e.g., the controller 2143, etc.) also includes a communications interface 2148, which facilitates communication with (e.g., to and from, etc.) other components of the system 2100 (e.g., the control system 2102, etc.). As described elsewhere herein, the communications interface 2148 may facilitate wired communication (e.g., through CAN, Ethernet, communication of power, etc.) and/or wireless communication (e.g., through Bluetooth, Wi-Fi, radio transmission, inductive transmission of energy, etc.). All such combinations and variations are contemplated.

In some embodiments, the PPE 2140 includes additional, fewer, and/or different components. For example, the PPE 2140 may include one or more energy storage and/or supply devices (e.g., batteries, capacitors, solar panels, and/or other types of power supplies, etc.), which may provide energy to components of the PPE 2140, for example to power the PPE 2140. In some embodiments, the PPE 2140 includes one or more user interface elements (e.g., input devices, output devices, etc.), for example to provide information to one or more users, connected systems, and/or a surrounding environment (e.g., adjacent personnel, etc.). By way of example, the interface elements may include touch displays, heads up displays, augmented reality displays, and/or virtual reality displays, as well as buttons, switches, knobs, touchscreens, microphones, cameras, or other input/output devices to communicate information and/or data (e.g., sensed data, sensed information, commands, instructions, etc.) with other components of the system 2100.

In some embodiments, the PPE 2140 includes additional, fewer, and/or different components. For example, the PPE 2140 may also include a cooling system (e.g., a fan, a mister, a heat exchanger, and/or another type of cooling element or device, etc.) to cool a user of the PPE 2140. It should be understood that while components of the PPE 2140 are shown as part of the PPE 2140, it is contemplated that in other embodiments the components of the PPE 2140 are split between a plurality of elements. For example, in some embodiments the controller 2143 is supported by a first portion or structure of the PPE 2140 (e.g., a wearable puck or block, etc.), while the sensor 2142 is supported by a second portion or structure of the PPE 2140 (e.g., a surface or structure of a hardhat, a pair of glasses, a vest, a lanyard, etc.).

As briefly discussed herein, the PPE 2140 includes the sensor 2142. While the PPE 2140 is shown to include a single sensor 2142, it is contemplated that in other embodiments the PPE 2140 includes a plurality of sensors 2142. In an exemplary embodiment, the sensor 2142 is configured to obtain (e.g., collect, determine, sense, etc.) information associated with a status of the PPE 2140, a surrounding environment, and/or a user of the PPE 2140. Further, the sensor 2142 (e.g., the controller 2143, via the communications interface 2148, etc.) may be configured to communicate the information to components of the system 2100 (e.g., the control system 2102, etc.), for example for analysis and/or decision making based on the information associated with the PPE 2140.

According to an exemplary embodiment, the sensor 2142 is a wave sensor. However, and as discussed herein, it is contemplated that in other embodiments the sensor 2142 is another suitable sensor and/or combination of sensors (e.g., mapping or imaging sensors, position sensors, orientation or acceleration sensors, environmental sensors, biometric sensors, etc.).

According to an exemplary embodiment, the sensor 2142 is configured to determine properties or characteristics associated with the PPE 2140, a user or wearer of the PPE 2140, and/or an environment around the PPE 2140 (e.g., movement, acceleration, etc.). For example, in some instances, the sensor 2142 is configured to obtain direction and/or orientation information associated with the PPE 2140, for example to determine which direction a user of the PPE 2140 is facing, looking, and/or moving. In some instances, the direction and/or orientation information may be used for fall and/or hit detection associated with the PPE 2140. In other instances, the sensor 2142 is configured to obtain direction and/or movement information associated with a user of the PPE 2140, for example to monitor a state or condition of the user (e.g., a heart rate, a movement speed, breathing or respiratory patterns, etc.). In other instances, the sensor 2142 is configured to obtain information associated with an environment around the PPE 2140, for example to detect the presence and/or movement of an object around the PPE 2140 (e.g., a direction, speed, and/or path of the object, etc.) to detect if an object is on a collision course with the PPE 2140.

Referring still to FIG. 21, the system 2100 is shown to include a remote device, an external device, an external system, or an external space, shown as remote device 2160. In some embodiments, the remote device 2160 is or includes one or more sensors, shown as a sensor 2162. The sensor 2162 may be a wave sensor (e.g., a millimeter wave sensor, etc.), and/or another suitable sensor or combination of sensors described herein. Similar to other devices/sensors described herein, the remote device 2160 (e.g., the sensor 2162) may be configured to obtain information associated with conditions at or surrounding the remote device, and communicate the information to one or more components of the system 2100 (e.g., the control system 2102, etc.).

According to an exemplary embodiment, the remote device 2160 (e.g., the sensor 2162) is a device that monitors the conditions and/or operations at a location. For example, the remote device 2160 may be a job site manager device that monitors the conditions (e.g., position, movement, tasks, statuses, etc.) of individuals and/or equipment at a job site. In other embodiments, the remote device 2160 is a storage monitoring device, for example that monitors the conditions of individuals and/or equipment at one or more storage and/or rental facilities. In yet other embodiments, the remote device 2160 may be a manufacturing site manager devices, which monitors the conditions of individual and/or equipment at one or more manufacturing facilities. All such embodiments and combinations are contemplated herein.

In some embodiments, the remote device 2160 is a user device. For example, the remote device 2160 may be a smartphone, tablet, laptop, desktop computer, and/or another suitable computing system or device. In an exemplary embodiment, the user device may be used to monitor conditions (e.g., presence, health status, characteristics, position, movement, etc.) of one or more persons at a location (e.g., a job site, storage facility, manufacturing facility, etc.). In other embodiments, the remote device 2160 is one or more tools (e.g., power tools, end effectors, machine accessories, etc.) at a location.

Referring still to FIG. 21, the system 2100 is shown to include a connectivity system, a connectivity hub, a connectivity device, or a connectivity module, shown as connected system 2180. In some embodiments, the connected system 2180 is the connectivity module 1718 of FIG. 17 and/or the connectivity hub 2018 of FIG. 20, which, and as described herein, facilitates communication between one or more vehicles, machines, and/or control systems. In this sense, in some example scenarios the control system 2102 may be implemented with, or as a part of the connected system 2180 (e.g., and/or connected via the connection 2112).

According to an exemplary embodiment, the connected system 2180 is configured to obtain information relating to one or more connected vehicles, machines, control systems, and/or PPEs, and may communicate the information to one or more components of the system 2100 (e.g., the control system 2102). For example, the connected system 2180 may obtain information relating to one or more work machines at a job site (e.g., an operating status, a task status, etc.) and/or one or more PPEs at a job site (e.g., movement information, information associated with a user of the PPE, etc.), and communicate that information to the control system 2102. As will be described herein, the control system 2102 may obtain the information from the connected system 2180, assess the information, and/or implement one or more controls or decisions based on the information (e.g., provide an instruction to control or stop operation of a work machine, provide an instruction to present or provide a notification to a user of the PPE or the surrounding environment, etc.).

In some embodiments the connected system 2180 functions as a site manager, for example to monitor and/or control various operations throughout a site. In this sense, the connected system 2180 may monitor the conditions (e.g., presence, health status, position, movements, tasks, etc.) of individuals and/or equipment on a jobsite (e.g., via one or more sensors, via information obtained from the machine 2120, the PPE 2140, the remote device 2160, etc.), and/or may control one or more machines or pieces of equipment on the jobsite, based on such information. In some instances, the connected system 2180 communicates the information associated with the job site conditions to the control system 2102, which may assess the information and/or provide one or more commands or instructions to the connected system 2180 to be implemented. In this way, the control system 2102 may communicate commands or instructions for the connected system 2180 to implement, for example to control one or more machines or pieces of equipment on the jobsite.

Referring still to FIG. 21 generally, the control system 2102 can communicate with (e.g., to and from, etc.) the components of the system 2100. For example, the control system 2102 may obtain information and/or data obtained (e.g., collected, sensed, etc.) from one or more sensors of the machine 2120, the PPE 2140, and/or the remote device 2160. Further, the control system 2102 may obtain information and/or data obtained by the connected system 2180. In some embodiments, the control system 2102 may assess (e.g., analyze, process, etc.) the information, and implement one or more actions and/or instructions based on the information.

For example, using in the obtained information and/or data, the control system 2102 may provide a command or instruction to the machine 2120, and the machine 2120 (e.g., a controller, etc.) may process the command or instruction to carry out an action. As non-limiting examples, the actions can include preventing or limiting an operation of the machine 2120 (e.g., stopping movement, preventing or limiting further movement, turning the machine off, putting the machine in standby mode, etc.). The actions can also include causing operations of the machine 2120 or a portion thereof (e.g., causing the machine to move off or away from a site or an active zone at a site, causing the machine to lower a platform, causing the machine to activate a climate control system or a lighting system, causing the machine to lock an ignition system or a steering system, etc.). In this regard, the control system 2102 may be configured to provide a command or an instruction to the machine 2120, for example to limit or prevent potentially hazardous operations of the machine 2120, and/or cause automatic operation of the machine 2120 to limit or prevent potentially hazardous conditions at or around the machine 2120.

Further, using the obtained information and/or data, the control system 2102 may provide a command or instruction to the PPE 2140, and the PPE 2140 may process the command or instruction to carry out an action. As a non-limiting example, the control system 2102 may determine that the PPE 2140 is within the machine 2120 and/or that a user associated with the PPE 2140 is exhibiting abnormal characteristics (e.g., elevated heart rate, increased temperature, labored or slow breathing, etc.). The control system 2102 may provide a command or instruction to the PPE 2140 to turn on a cooling system (e.g., of the PPE 2140, etc.), or an instruction to provide a notification or warning via the PPE 2140 (e.g., provide an audible notification to the user, sound an alarm to alert the surrounding area, etc.). In this regard, the control system 2102 may be configured to provide a command or an instruction to the PPE 2140, for example to alert a user and/or the surrounding area of a potentially hazardous condition.

In some embodiments, the available actions to be performed based on the PPE 2140 are dependent on an identify of the PPE 2140 or a wearer of the PPE 2140. For example, a PPE 2140 associated with a site manager may have permissions to perform a first plurality of actions or all possible actions, while a PPE 2140 associated with a maintenance worker may have permissions to perform a second plurality of actions. The second plurality may be different than and/or smaller than the first plurality of actions.

Yet further, using the obtained information and/or data, the control system 2102 may provide a command or instruction to the remote device 2160 and/or the connected system 2180, which may process the command or instruction to carry out one or more actions. For example, the control system 2102 may determine that a user associated with the machine 2120 and/or the PPE 2140 is exhibiting abnormal characteristics, and/or provide a command or instruction to the remote device 2160 to provide an alert or notification (e.g., sound an alarm within a building, provide an interface with a notification at a jobsite, etc.). Further, the control system 2102 may provide a command or instruction to the connected system 2180, for example to call another connected machine or PPE (e.g., a user, etc.) to the site for assistance and/or replacement, and/or provide instructions to a set of connected machines within the area to move out of a path of the machine 2120, etc.

Beneficially, the ability of the control system 2102 to obtain information from the components of the system 2100 (e.g., the machine 2120, the PPE 2140, the remote device 2160, the connected system 2180, etc.), assess the various inputs and/or pieces of information, and/or communicate different commands or instructions to the various components, offers an integrated system that allows for automatic actions and/or responses to be taken based on the information obtained from the different components at a site or location.

In some embodiments, the control system 2102 is also configured to obtain information from the components of the system 2100, as described herein, and/or assess the various inputs and pieces of information using one or more sets of data or information (e.g., associated with a specific user, associated with a general population of similarly situated users, etc.).

For example, in some embodiments an operator or user may be identifiable based on an identifier (e.g., a user identifier, etc.). The identifier may be used to access and/or operate the work machine 2120 (e.g., a pin or code associated with an individual user or operator), may be an association with the PPE 2140 (e.g., a specific PPE 2140 is associated with a specific user identified by a unique identifier, etc.), may be associated with an individual assigned to a specific task or operation (e.g., via the tasks or management functions outlined via the connected system 2180, etc.), and/or may be assigned to a user when using or interfacing with the remote device 2160 (e.g., via an application on a user device associated with the user, etc.).

According to some embodiments, the control system 2102 is configured obtain the operating information described herein, and associate the operating information with a specific operator, for example over a period of time. In this sense, the control system 2102 may be configured to obtain, store, and/or analyze information associated with specific users'operating trends or tendencies over a period of time, for example to generate an operator specific profile. When assessing the information that is received from components of the system 2100 (e.g., conditions from the machine 2120, conditions from the user's PPE 2140, etc.), the control system 2102 can compare the received information with the information in the operator's profile, for example to determine if the operator's current operating conditions are abnormal (e.g., not normal, nonstandard, irregular, atypical, etc. relative to the operator's normal operating trends or tendencies, etc.). In some instances, the control system 2102 may assess the received information to determine whether the current operator's operating conditions are outside a threshold of normal operating conditions. If outside the threshold, the control system 2102 may be configured to implement one or more of the operations described herein.

According to other embodiments, the control system 2102 is configured to obtain operating information described herein, and compare the operating information with information and/or characteristics associated with similarly situated operators. As non-limiting examples, the information associated with similarly situated operators may be based on conditions that are similar those of the current operations, such as machine type, task type, location, time of day, weather conditions, and/or other suitable information. When assessing the information that is received from components of the system 2100 (e.g., conditions from the machine 2120, the user's PPE 2140, the connected system 2180, etc.), the control system 2102 can compare the received information with information of the similarly situated operators, for example to determine if the operator's current operating conditions are abnormal (e.g., relative to a population of operator's under similar conditions, etc.). In some instances, the control system may assess the received information to determine whether the current operator's operating conditions are outside a threshold of abnormal operating conditions, and/or implement one or more operations described herein. All such combinations and variations are contemplated herein.

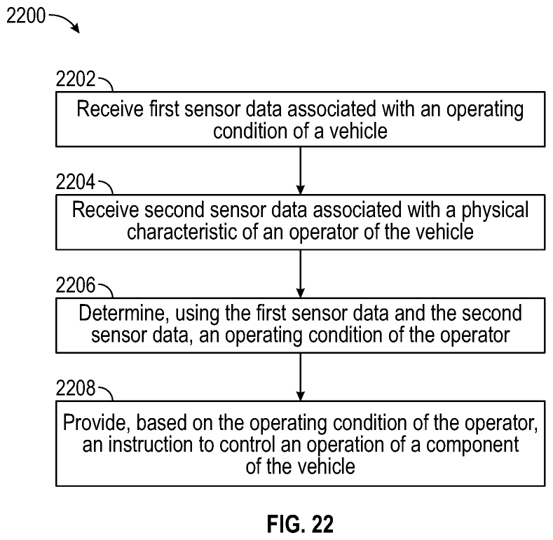

Referring now to FIG. 22, a process 2200 for performing or implementing an action with or based on information associated with a vehicle and/or an operator of the vehicle is shown. The steps of the process 2200 may be performed in whole or in part by one or more components of the devices and/or systems of FIGS. 16-6. For example, one or more of the steps of the process 2200 may be implemented via the controller 1644 of the work machine 1620 of FIG. 16, the connectivity module 1718 of FIG. 17, the connectivity hub 2018 of FIG. 20, and/or the control system 2102 of FIG. 21. All such combinations and embodiments are contemplated herein.

Step 2202 is shown to include receiving first sensor data associated with an operating condition of a vehicle. According to an exemplary embodiment, the first sensor data is received from a first sensor, which may be a wave sensor and/or another suitable sensor described herein. The operating condition of the vehicle may be a power status of the vehicle (e.g., powered on/off, etc.), a mode of the vehicle (e.g., an operating mode, a standby mode, a locked mode, etc.), a movement characteristic of the vehicle (e.g., speed, direction, acceleration/deceleration, path of travel, etc.), a configuration of one or more components of the vehicle (e.g., the implement or platform is elevated or in use, etc.). In other embodiments, the operating condition is another suitable condition described herein (e.g., environmental conditions, a task or planned operation of the vehicle, a site layout or configuration, etc.).

As described herein, the first sensor data may be received via a wired or wireless communication protocol. In this sense, the first sensor may be a component of the vehicle; however, it is contemplated that in other embodiments the first sensor is otherwise positioned or configured (e.g., mounted on the vehicle, a sensor of a PPE, a sensor of a remote device, etc.).

Step 2204 is shown to include receiving second sensor data associated with a physical characteristic of an operator of the vehicle. According to an exemplary embodiment, the second sensor data is received from a second sensor, which may be a wave sensor and/or another suitable sensor described herein. The second sensor may be different than the first sensor; however, it is contemplated that in some embodiments the first sensor is the same as the second sensor. Similarly, the first sensor and/or the second sensor may be configured to communicate sensed information and/or data via wired or wireless communications protocols, which may be the same or different.

As described herein, the characteristic of the operator may be associated with vital information the operator exhibits (e.g., heart rate, respiratory rate, body temperature, etc.), which may provide an indication of a state of the operator (e.g., stressed, nervous, experiencing heat exhaustion, whether the operator is tired or drowsy, etc.). Further, and as described elsewhere herein, the characteristic of the operator may be or include body characteristics (e.g., posture, movement, positioning, twitching, rapid movements, etc.), movement trends or tendencies (e.g., slouching, slumping, standing, sitting, where the operator is facing or looking, etc.), and/or other suitable information relating to the operator.

In some embodiments, the process 2200 includes receiving sensor data associated with a component of the vehicle, a space associated with the vehicle, and/or another user. For example, in some embodiments the process 2200 includes receiving third sensor data, for example relating to a component of a vehicle (e.g., a height of a platform, whether a user or users are present on the platform, a positioning and/or posture of one or more users on the platform, etc.), one or more spaces of the vehicle (e.g., conditions of an operating compartment or area of the vehicle, etc.), and/or one or more spaces surrounding the vehicle (e.g., whether there are objects around the vehicle, whether there are moving objects, whether the vehicle is planned to cross paths with one or more objects, etc.). In some embodiments, the third sensor data is received from a third sensor (e.g., via a wired or wireless communication protocol, etc.). As discussed herein, the third sensor may be different than, or the same as, the first sensor and/or the second sensor.

Step 2206 is shown to include determining an operating condition of the operating using the first sensor data and the second sensor data. As a non-limiting example, the process 2200 may include determining that an operator has powered on the vehicle (e.g., via the first sensor data, etc.), but that the operator is standing in the working area and is exhibiting rapid hand movements (e.g., twitching, via the second sensor data, etc.). Based on this information, it may be determined that the operator is exhibiting signs of being stressed (e.g., elevated stress levels, etc.). As another non-limiting example, the process 2200 may include determining that an operator is beginning an operation to raise a platform of the vehicle (e.g., via the first sensor data, etc.), but that the operator is exhibiting labored or slow breathing (e.g., based on the second sensor data, etc.). Based on this information, it may be determined that the operating is exhibiting signs of a potential heart condition, or heat exhaustion.

Step 2208 is shown to include providing an instruction to control an operation of a component of the vehicle based on the operating condition of the operator. For example, using the determined operating condition of the operator, the process 2200 includes providing an instruction (e.g., a command, control, operation instruction, etc.) to control the vehicle, for example to limit or prevent potentially hazardous conditions associated with the vehicle.

As described herein, the instruction or action may be a control instruction to limit or prevent movement of one or more components of the vehicle (e.g., an instruction to power the vehicle off, an instruction to stop the motor, an instruction to lock the platform or motor controls, etc.). In some embodiments, the instruction is a control instruction to automatically initiate a movement of one or more components of the vehicle (e.g., an instruction to automatically lower the implement or platform, an instruction to move the vehicle from a work site, an instruction to move the vehicle from a predicted path of another vehicle or individual, etc.). In other embodiments, the instruction is a control instruction to provide a notification and/or warning associated with the determined operator condition (e.g., via an interface of the vehicle, via a light or audible device, a call for assistance, etc.).

In some embodiments, the instruction is provided based on an assessment of additional information. For example, in some instances process 2200 includes comparing the determined condition associated with the operator to other operating condition information (e.g., historic user-specific operating condition information, operating condition information associated with similarly situated operators, etc.). In this sense, process 2200 may include comparing the determined operator conditions (e.g.. current operator conditions, etc.) to other operating condition information (e.g., user-specific information, similarly situated operators, etc.) to determine whether the current operator conditions are normal or abnormal (e.g., not normal, nonstandard, irregular, atypical, etc.).

In other embodiments, the instruction is provided to one or more additional components, systems, and/or devices. For example, the instruction may be provided to a PPE associated with the operator, for example to provide a notification or warning to the operator and/or those in a surrounding area. In some instances, the instruction is provided to a connected system or device, and/or a remote device, for example to assist in controlling operation of the vehicle, provide a warning to the associated areas and/or people, and/or to report the detected condition. All such embodiments and combinations described herein are contemplated.

As a first illustrative example, a vehicle (e.g., a lift, etc.) may be equipped with a first sensor and a second sensor (e.g., a wave sensor, etc.) at/in an operating compartment of the vehicle. The first sensor may be used to determine that the vehicle has been powered on (e.g., via a sensor coupled with the actuator or prime mover, etc.), and/or that the platform is in a retracted position (e.g., via a hydraulic sensor coupled with the arm or boom, etc.). The second sensor may be used to determine that the operator is positioned within the operating compartment and/or is exhibiting certain characteristics or qualities.

For example, the second sensor may be used to determine that the operator is breathing rapidly and/or twitching, indicating that the operator may be experiencing elevated levels of stress. Based on this determined information, a control instruction may be provided to the vehicle, for example to limit or prevent the operator from moving the vehicle. Similarly, the second sensor may be used to determine that the operator is looking away from the path of travel from the vehicle (e.g., frequently looking away, has fallen asleep and is slouched looking downward, is drowsy and their head is nodding, etc.). Based on this determined information, a control instruction may be provided to the vehicle, for example to limit or prevent the vehicle from moving (e.g., stop the vehicle, power off the vehicle, etc.).

As a second illustrative example, a vehicle (e.g., a lift, etc.) may be equipped with a third sensor at an exterior of the vehicle (e.g., on or at a platform, etc.). The third sensor may be used to determine whether there are users present on the platform of the vehicle and/or how many users there are. For example, in some instances, the third sensor may be used to determine that there are 2 users present on the platform. Based on this information, a control instruction may be provided to the vehicle, for example to automatically lower the platform and/or provide a notification (e.g., via an interface, audible instruction, etc.) indicating the maximum capacity of the platform (e.g., 1 user, etc.). Similarly, the third sensor may be used to determine a positioning and/or posture of the user present on the platform (e.g., standing on a step, leaning over a railing, etc.). Based on this information, a control instruction may be provided to the vehicle, for example to limit and/or prevent the platform from moving, or to lower the platform until an appropriate positioning/posture of the user is obtained.

It should be understood that it is contemplated that any and/or all of the information obtained from the sensors may be used alone, or in any suitable combination, for example to provide the instructions to control any and/or all operations of the vehicle described herein. For example, the process 2200 may use information associated with the vehicle (e.g., the first sensor information), an operator of the vehicle (e.g., the second sensor information), and/or one or more components or spaces associated with the vehicle itself or other objects (e.g., the third sensor information, etc.), for example to control operations of the vehicle (e.g., limit or prevent, cause movement of the platform, provide a notification or alert to the operator, etc.). All such embodiments and combinations are contemplated herein.

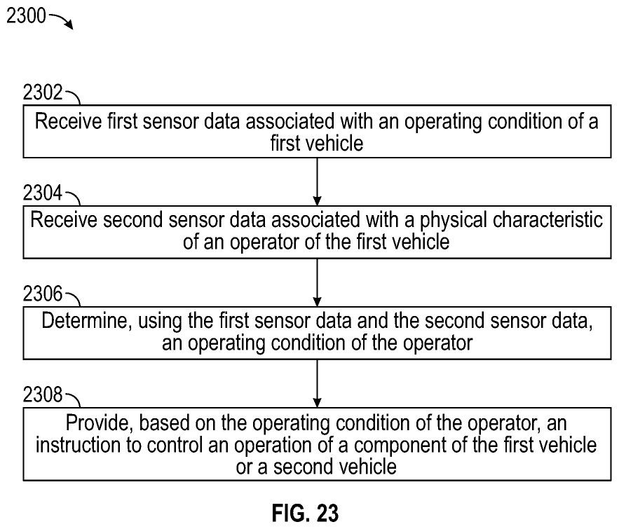

Referring now to FIG. 23, a process 2300 for performing or implementing an action with or based on information associated with one or more vehicles and/or an operator of a vehicle is shown. In particular, the process 2300 may be for performing or implementing one or more actions based on information associated with one or more vehicles, operators, and/or users associated with a fleet of vehicles and/or a site (e.g., a job site, a storage facility, a manufacturing facility, etc.). The steps of the process 2300 may be performed in whole or in part by one or more components of the devices and/or systems of FIGS. 16-6. For example, one or more of the steps of the process 2300 may be implemented via the controller 1644 of the work machine 1620 of FIG. 16, the connectivity module 1718 of FIG. 17, the connectivity hub 2018 of FIG. 20, and/or the control system 2102 of FIG. 21. The process 2300 may include similar steps as the process 2200, which may be implemented using the same and/or similar components. All such combinations and embodiments are contemplated herein

Step 2302 is shown to include receiving first sensor data associated with an operating condition of a first vehicle. In an exemplary embodiment, step 2302 of FIG. 23 is the same as or similar to step 2202 of FIG. 22. For example, the first sensor data may be received from a first sensor (e.g., a wave sensor, another sensor, etc.) of a first vehicle (e.g., via wired or wireless communication protocols, etc.), and/or may relate to one or more operating conditions of the first vehicle described herein (e.g., a power status, mode of operation, movement characteristic, configuration, etc.).

Step 2304 is shown to include receiving second sensor data associated with a physical characteristic of an operator of the first vehicle. In an exemplary embodiment, step 2304 of FIG. 23 is the same as or similar to the step 2204 of FIG. 22. In this sense, the second sensor data may be received from a second sensor (e.g., a wave sensor, another sensor, etc.) of the first vehicle, which may be the same as or different than the first sensor. The characteristic of the operator may be associated with vital information, body characteristics of the operator, movement characteristics, movement trends or tendencies, and/or other suitable information described herein.

Step 2306 is shown to include determining an operating condition of the operator using the first sensor data and the second sensor data. In an exemplary embodiment, step 2306 of FIG. 23 is the same as or similar to step 2206 of FIG. 22. In this regard, step 2306 may use the first sensor data and/or the second sensor data (and/or additional sensor data) to determine conditions or characteristics associated with how the operator is acting or operating the first vehicle. In some instances, this condition is compared to other operating condition information (e.g., historic operating conditions of the user, similarly situated operators under similar conditions, etc.).

Step 2308 is shown to include providing an instruction to control an operation of a component of the first vehicle or a second vehicle based on the operating condition of the operator. In some embodiments, step 2308 is the same as or similar to step 2206 of FIG. 22. For example, in some scenarios step 2308 includes providing an instruction to control an operation of the first vehicle (e.g., to limit or prevent movement of one or more components of the first vehicle, to cause or control movement of one or more components of the first vehicle, to cause or provide a notification and/or alert associated with the determined condition of the operator, etc.).

In some embodiments, step 2308 includes providing an instruction to control operation of a second vehicle (e.g., another vehicle of the fleet, etc.). For example, step 2308 may include providing an instruction to limit or prevent movement of one or more components of a second vehicle (e.g., an instruction to stop movement of the second vehicle in a path toward the first vehicle, an instruction to stop movement of a platform of the second vehicle based on a positioning/retraction of a platform of the first vehicle, etc.). In some instances, the instruction initiates control or movement of one or more components of the second vehicle (e.g., an instruction to move the second vehicle out of a path of the first vehicle, an instruction to move the second vehicle toward the first vehicle to provide assistance, etc.). In other instances, the instruction is a control instruction to provide a notification and/or alert (e.g., at the second vehicle, to an operator of the second vehicle, to a PPE associated with the second vehicle, etc.) associated with the operator condition (e.g., via an interface of the second vehicle, via a light or horn of the second vehicle, etc.).

In yet other embodiments, the process 2300 includes providing one or more instructions to one or more additional components, systems, and/or devices. For example, an instruction may be provided to a PPE associated with the operator, for example to provide a notification or warning to the operator and/or those in a surrounding area. Further, an instruction may be provided to a connected system or device, and/or a remote device, for example to assist in controlling operation of one or more additional vehicles (e.g., alert a vehicle to provide assistance, alert an individual/vehicle to replace the operator and/or vehicle, etc.), provide a warning to the associated areas and/or people (e.g., alert other vehicles or persons in the surrounding area of the operator condition, etc.), and/or to report the detected condition. All such embodiments and combinations described herein are contemplated. All such embodiments and combinations are contemplated herein.

As an illustrative example, one or more vehicles of a connected system or fleet may be equipped with one or more sensors. For example, a first vehicle (e.g., a lift device, etc.) may be equipped with a first sensor and a second sensor (e.g., a wave sensor, etc.) at/in an operating compartment of the first vehicle. The first sensor may be used to determine that the first vehicle has been powered on and/or is operating. The second sensor may be used to determine that the operator is positioned within the operating compartment and/or is exhibiting certain characteristics or qualities.

For example, the second sensor may be used to determine that the operator is breathing slowly and/or falling asleep, indicating that the operator may be tired to experiencing signs of exhaustion. Based on this determined information, a control instruction may be provided to a second vehicle (e.g., another vehicle at a job site, another vehicle of the fleet, etc.), for example to limit or prevent the second vehicle from moving toward the first vehicle and/or to control the second vehicle to move away from a path of travel of the first vehicle. In some embodiments, the control instruction includes an alert or notification provided to the second vehicle, for example to provide a warning to other vehicles, operators, and/or users located around the first vehicle.

In some instances, operator information of operators of a plurality of vehicles is received, determined, and/or assessed, for example to provide one or more control instructions based on the obtained information. For example, operator information of a plurality of operators at a site may be collected to assess operator conditions of a group of individuals at the site. As a non-limiting example, operator information of a plurality of operators at a manufacturing facility may be collected and assessed, for example to determine that the operators appear to be exhibiting signs of exhaustion, for example due to the elevated temperatures. Based on this information, one or more control instructions may be provided, for example to activate the cooling systems of the vehicle associated with the operators and/or to provide an alert to other operators of the fleet of the determined conditions (e.g., a temperature warning, a notification to maintain proper hydration techniques, etc.).

In some instances, the operator information (e.g., of one or more operators of a fleet of vehicles, etc.) may be used to provide control instructions associated with one or more operations of the fleet collectively. For example, a control instruction may be provided to a vehicle to move to another vehicle and/or location based on operator information, for example to provide assistance to the operator and/or to provide a replacement to the operator/vehicle. In some instances, the operator information is used to provide control instructions that limit or control vehicle operations within different zones or portions of the (e.g., establish a no-go zone for vehicles based on an operator condition, move one or more vehicles from a zone of a site based on an operator condition, etc.). In this regard, the systems and methods of the present application obtain information associated with the various conditions of vehicles (and components thereof, etc.), operators, and/or spaces at a site, assess that information, and automatically provide control decisions and/or responses, in order to limit and/or prevent potentially hazardous conditions and/or operations associated with an operator condition.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

It is important to note that the construction and arrangement of the various exemplary embodiments herein is illustrative only. Additionally, any element disclosed in one embodiment may be incorporated or utilized with any other embodiment disclosed herein. For example, the control system 2102 of FIG. 21 may be incorporated in the work machine of FIG. 16 and/or the systems of FIGS. 1-23. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A monitoring system, comprising:
a vehicle comprising an actuator or a motor, an implement driven by the actuator, and a first sensor; and
a controller configured to:
receive, from the first sensor, first sensor data associated with an operating condition of at least one of the actuator, the motor, or the implement;
receive, from a second sensor, second sensor data associated with a physical characteristic of an operator of the vehicle;
determine, using the first sensor data and the second sensor data, an operating condition of the operator; and
provide, based on the operating condition of the operator, an instruction to control an operation of at least one of the actuator, the motor, or the implement of the vehicle.

2. The monitoring system of claim 1, wherein the operating condition of at least one of the actuator or the implement is an on/off state of the actuator or the motor, or a height of the implement.

3. The monitoring system of claim 1, wherein the second sensor is an operator sensor configured to detect the physical characteristic of the operator, the physical characteristic is at least one of a heart rate of the operator, a breathing characteristic of the operator, a posture of the operator, a direction the operator is facing, or a direction the operator is looking.

4. The monitoring system of claim 1, wherein the instruction controls the actuator to prevent movement of the vehicle.

5. The monitoring system of claim 1, wherein the instruction controls the implement to prevent movement of the implement.

6. The monitoring system of claim 1, wherein the implement is a platform, and wherein the instruction controls the platform to lower the platform.

7. The monitoring system of claim 1, wherein the controller is configured to:
receive, from a third sensor, third sensor data associated with a condition of the implement, wherein the implement is a platform and the condition is at least one of a number of users on the platform, a posture of one or more users on the platform, or a positioning of one or more users on the platform,
wherein the operating condition of the operator is based on the third sensor data.

8. The monitoring system of claim 1, wherein the first sensor data is received via a wired communication protocol and the second sensor data is received via a wireless communication protocol.

9. The monitoring system of claim 1, wherein the controller is configured to:
compare the operating condition of the operator to an operator profile of the operator, the operator profile comprising a log of historic operating conditions of the operator over a period of time; and
determining, based on the comparison, that the operating condition of the operator is different relative to operating trends of the operator stored in the operator profile.

10. A monitoring system for monitoring a plurality of vehicles at a site, the monitoring system comprising:
a controller configured to:
receive, from a first sensor, first sensor data associated with an operating condition of a first vehicle;
receive, from a second sensor, second sensor data associated with a physical characteristic of an operator of the first vehicle;
determine, using the first sensor data and the second sensor data, an operating condition of the operator; and
provide, based on the operating condition of the operator, an instruction to control an operation of at least one of the first vehicle or a second vehicle.

11. The monitoring system of claim 10, wherein the second sensor is an operator sensor configured to detect the physical characteristic of the operator, the physical characteristic is at least one of a heart rate of the operator, a breathing characteristic of the operator, a posture of the operator, a direction the operator is facing, or a direction the operator is looking.

12. The monitoring system of claim 10, wherein the instruction controls the operation of the second vehicle to move the second vehicle relative to the first vehicle.

13. The monitoring system of claim 10, wherein the instruction controls the operation of the first vehicle to stop a motor of the first vehicle and lock motor controls of the first vehicle.

14. The monitoring system of claim 10, wherein the operation further comprises:
receiving, from a second sensor on a piece of protective equipment warn by the operator, third sensor data associated with the physical characteristic of the operator of the first vehicle,
wherein providing the instruction to control the operator of at least one of the first vehicle or the second vehicle is based on the third sensor data.

15. A monitoring system comprising:
a vehicle;
a work machine; and
a user device comprising:
a communication interface configured to be communicably coupled to each of the vehicle and the work machine;
a user interface; and
a controller configured to:
receive, via the user interface, a first input from a user;
verify the first input based on a database; and
provide, via the user interface, access to data associated with at least one of the vehicle or the work machine based on the verification of the first input.

16. The monitoring system of claim 15, wherein the user device comprises a mount and is configured to be removably coupled to one of the vehicle or the work machine via the mount, the user device is configured to communicably couple to the vehicle or the work machine when positioned within a threshold distance of one of the vehicle or the work machine.

17. The monitoring system of claim 15, wherein the controller is further configured to:
lock at least one of the vehicle or the work machine in response to the first input being unverifiable.

18. The monitoring system of claim 15, wherein the controller is further configured to:
limit available data associated with at least one of the vehicle or the work machine based on the first input;
limit control, via the communication interface, of operation of at least one of the vehicle or the work machine based on a second input of the user; and
provide a signal, via the communication interface, to one of the vehicle or the work machine causing one of the vehicle or the work machine to perform an action.

19. The monitoring system of claim 15, wherein the controller is further configured to:
engage, via a signal sent from the communication interface, the work machine based on a first position of the user device;
disengage, via a signal sent form the communication interface, the work machine based on a second position of the user device;
engage, via a signal sent from the communication interface, the vehicle based on the second position of the user device; and
engage, via a signal sent from the communication interface, each of the work machine and the vehicle based on a third position of the user device.

20. The monitoring system of claim 15, wherein the user device is configured to communicably coupled to at least one of the vehicle or the work machine based on selection provided by the user or a distance from the vehicle or the work machine.
